(19) United States
(12) Patent Application Publication
(10) Pub. No.: US 2013/0100490 A1
(43) Pub. Date: Apr. 25, 2013

(54) MANAGEMENT APPARATUS, MANAGEMENT METHOD, AND COMPUTER-READABLE MEDIUM

(71) Applicant: CANON KABUSHIKI KAISHA, Tokyo (JP)

(72) Inventor: Takashi Imoto, Yokohama-shi (JP)

(73) Assignee: CANON KABUSHIKI KAISHA, Tokyo (JP)

(21) Appl. No.: 13/623,949

(22) Filed: Sep. 21, 2012

(30) Foreign Application Priority Data
Oct. 21, 2011 (JP) 2011-232125

(51) Int. Cl. G06K 15/02

(52) U.S. Cl. 358/1.15

(57) ABSTRACT

A management apparatus, which manages status information of a printing apparatus that processes a print job, comprises: a status acquisition unit configured to acquire, as the status information, device status information of the printing apparatus and job status information of a print job processed by the printing apparatus; a status analysis unit configured to analyze the status information acquired by the status acquisition unit; and a change unit configured to change a status item included in the status information acquired by the status acquisition unit at a next or later time based on information analyzed by the status analysis unit.

### BACKGROUND OF THE INVENTION

1. Field of the Invention

The present invention relates to a management apparatus and management method, and a computer-readable medium, which are required to efficiently manage statuses associated with a printing apparatus.

2. Description of the Related Art

As a conventional status notification method of a printing apparatus, a mode of acquiring a required status every time it is required, and a method of acquiring status information from a printing apparatus at given time intervals are known. For example, a technique disclosed in Japanese Patent Laid-Open No. 10-303931 has proposed a method of acquiring a specific status when the user selects a display unit of status information of a printing apparatus. Also, a technique disclosed in Japanese Patent Laid-Open No. 2002-297336 has proposed a method in which a host computer as a monitoring apparatus accesses a printing apparatus at given time intervals to monitor a status of the printing apparatus.

However, when the number of status items of a printing apparatus increases, cache data also increases, resulting in an increase in cost of physical hardware and a heavy load imposed on status response processing of the printing apparatus. As a result, other kinds of print processing and the like are adversely influenced. Furthermore, upon acquiring information from a printing apparatus connected via a network, data in large quantities are exchanged on the network, thus causing communication failures.

### SUMMARY OF THE INVENTION

Hence, the present invention provides a status management method which efficiently generates cache data upon acquisition of status data.

According to one aspect of the present invention, there is provided a management apparatus, which manages status information of a printing apparatus that processes a print job, comprising: a status acquisition unit configured to acquire, as the status information, device status information of the printing apparatus and job status information of a print job processed by the printing apparatus; a status analysis unit configured to analyze the status information acquired by the status acquisition unit; and a change unit configured to change a status item included in the status information acquired by the status acquisition unit at a next or later time based on information analyzed by the status analysis unit.

According to another aspect of the present invention, there is provided a management method for managing status information of a printing apparatus that processes a print job, comprising: acquiring, as the status information, device status information of the printing apparatus and job status information of a print job processed by the printing apparatus; analyzing the status information acquired in the acquiring step; and changing a status item included in the acquired status information at a next or later time based on analyzed information.

According to another aspect of the present invention, there is provided a non-transitory computer-readable medium storing a program for controlling a computer to function as: a status acquisition unit configured to acquire, as status information of a printing apparatus that processes a print job, device status information of the printing apparatus and job status information of a print job processed by the printing apparatus; a status analysis unit configured to analyze the status information acquired by the status acquisition unit; and a change unit configured to change a status item included in the status information acquired by the status acquisition unit at a next or later time based on information analyzed by the status analysis unit.

According to the present invention, communications between apparatuses are suppressed to prevent cache data from increasing.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of a system;

FIG. 2 is a block diagram showing an example of the hardware arrangement of a print server;

FIG. 3 is a block diagram of the print server;

FIG. 4 shows an example of a polling target table held by the print server;

FIG. 5 shows an example of a related status table held by the print server;

FIG. 6 shows an example of a job management table held by the print server;

FIG. 7 is a flowchart of status acquisition control processing;

FIGS. 8A and 8B are flowcharts of status cache data update control processing;

FIG. 9 is a flowchart of status item registration/release control processing;

FIGS. 10A and 10B show examples of an action table held by the print server;

FIG. 11 is an operation sequence chart when a client PC issues a status acquisition request;

FIGS. 12A and 12B are operation sequence charts when the client PC issues a listener registration/release request;

FIGS. 13A, 13B, and 13C are operation sequence charts when the client PC issues a print instruction;

FIGS. 14A, 14B, 14C, and 14D are operation sequence charts when the client PC issues a print instruction;

FIGS. 15A, 15B, and 15C are operation sequence charts when a medium-empty error has occurred in a printer;

FIGS. 16A, 16B, and 16C are operation sequence charts when the client PC issues a print cancel instruction; and

FIGS. 17A, 17B, 17C, and 17D are views showing examples of job status information held by a job management control unit.

### DESCRIPTION OF THE EMBODIMENTS

Embodiments of the present invention will be described in detail hereinafter with reference to the accompanying drawings. Note that the following embodiments do not limit the present invention according to the scope of the claims, and not all combinations of features described in the embodiments are indispensable to the solving means of the present invention.

### Embodiment

### System Arrangement

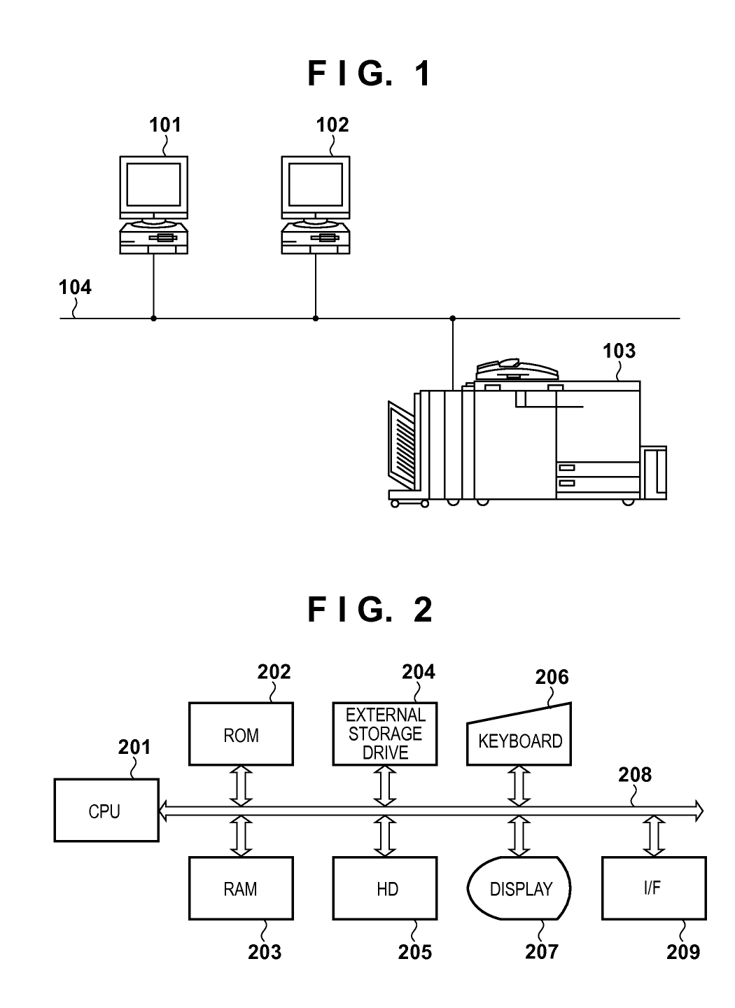

An example of the system arrangement of this embodiment will be described below with reference to the block diagram shown in FIG. 1. FIG. 1 shows the form in which a client PC 101, print server 102, and printer 103 are connected via a network (LAN) 104. The client PC 101 is used by an operator, and an application used to instruct print processing runs on the client PC 101. The print server 102 is a print server apparatus which manages and relays print processing by the printer 103. The printer 103 executes actual print processing according to a print instruction from the print server 102.

The client PC 101 receives an instruction from an operator who makes a print operation or a print instruction apparatus (not shown), and issues an instruction of print processing. The client PC 101 generates a print processing schedule for respective print instructions in consideration of the contents of instructed print documents and the operating status of the printer 103. Then, the client PC 101 issues print instructions to the print server 102 according to the generated print processing schedule. Note that print instructions from the client PC 101 to the print server 102 are issued automatically in correspondence with the print processing schedule by the client PC 101 or via operations of the operator.

The print server 102 has a function of converting a print instruction received from the client PC 101 into commands in an interpretable format of the printer 103, and a function of issuing a print instruction to the printer 103. The print server 102 also has a function of acquiring an operating status of the printer and a progress status of a print job from the printer 103, and a function of notifying the client PC 101 of the acquired statuses. Note that the operating status of the printer and the progress status of a print job will be inclusively referred to as “status” hereinafter, a status associated with a device will be referred to as “device status” hereinafter, and a status associated with a print job will be referred to as “job status” hereinafter. Furthermore, the print server 102 has a function of controlling the printer 103 to suspend a print job, the print instruction of which has already been issued. Note that the print server 102 may have other functions.

Upon reception of a print instruction from the print server 102, the printer 103 executes printout operations according to print settings designated as a print job. Note that the printer 103 may be an MFP (Multi Function Peripheral) having a print function or the like.

(Hardware Arrangement)

FIG. 2 is a block diagram showing an example of the hardware arrangement of the print server 102. A CPU 201 executes an application program, OS (Operating System), a network printer control program, and the like, which are stored in an HD (Hard Disk) 205 as a storage unit. The CPU 201 controls to temporarily store information, files, and the like required to execute the programs in a RAM 203.

A ROM 202 stores programs such as a basic I/O (Input/Output) program, and various data such as font data and template data used upon execution of document processing.

The RAM 203 functions as a main memory, work area, and the like of the CPU 201. The RAM 203 temporarily stores or holds, for example, a job management table 315 (to be described later), status cache data 314 (to be described later), and the like. The RAM 203 is an example of a temporary storage device.

An external storage drive 204 can load programs and the like stored in recording media such as a DVD and USB memory to the print server 102. The HD 205 is a storage unit which stores application programs, an OS, control programs, their related programs, and the like, and can store various data.

A keyboard 206 is used by the operator to input and instruct various commands and the like to the print server 102. The operator can input various commands to the print server 102 via other input devices (not shown) such as a pointing device (not shown) and microphone in addition to the keyboard 206. These input devices are connected to the CPU 201 via a serial port interface connected to a system bus 208. Alternatively, the input devices may be connected via other interfaces such as a parallel port and USB.

A display 207 displays information input from the keyboard 206, statuses, and the like. The system bus 208 controls data flows among respective components in the print server 102. A network interface 209 is a communication interface required to be connected to a LAN (Local Area Network) or the Internet. When the CPU 201 executes processes based on programs, the functions of the print server 102 and the processes of flowcharts are implemented, as will be described later.

Note that the hardware arrangement of the client PC 101 is the same as that of the print server 102 shown in FIG. 2. When a CPU of the client PC 101 executes processes based on programs stored in an HD or the like of the client PC 101, the print instruction function and the like of the client PC 101 are implemented. Likewise, the printer 103 also has a CPU, memory, and the like. When the CPU of the printer 103 executes processes based on programs stored in the memory or the like of the printer 103, the functions and the like of the printer 103 are implemented.

(Module Configuration of Print Server)

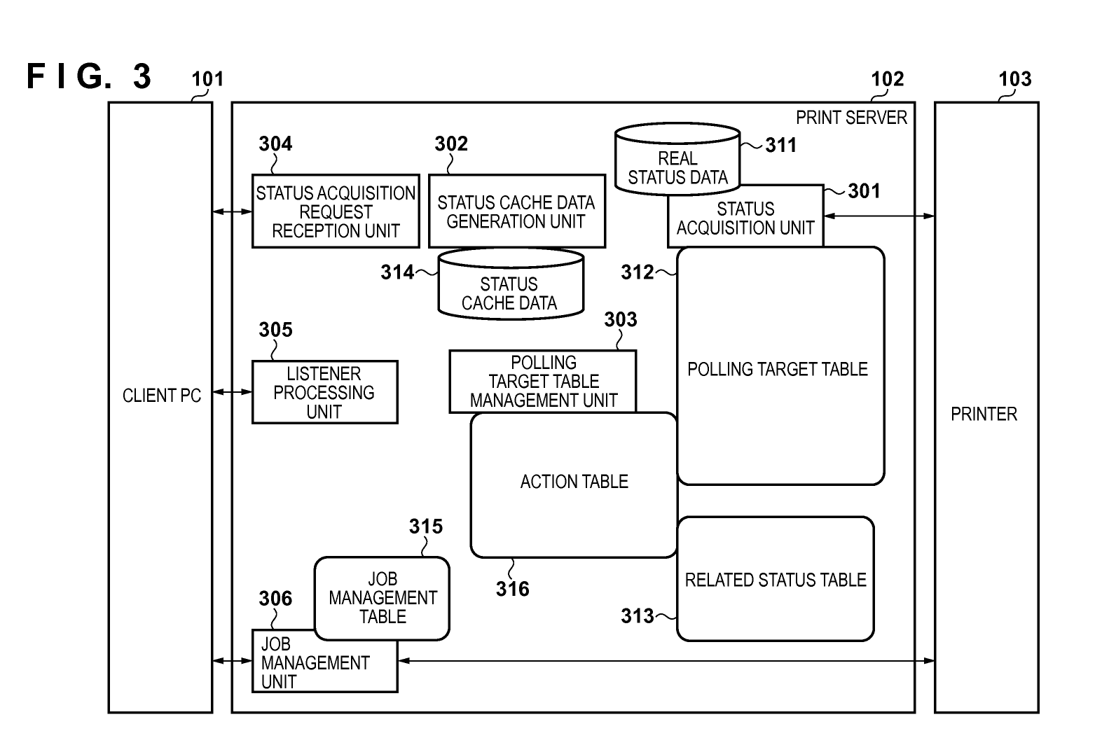

FIG. 3 is a block diagram of respective modules which operate on the print server 102. A status acquisition unit 301 periodically acquires statuses from a device such as the printer 103, and holds the statuses as real status data 311. Status items acquired by the status acquisition unit 301 from the device and acquisition conditions are managed using a polling target table 312. The status acquisition unit 301 acquires status items described in the polling target table 312 from the device.

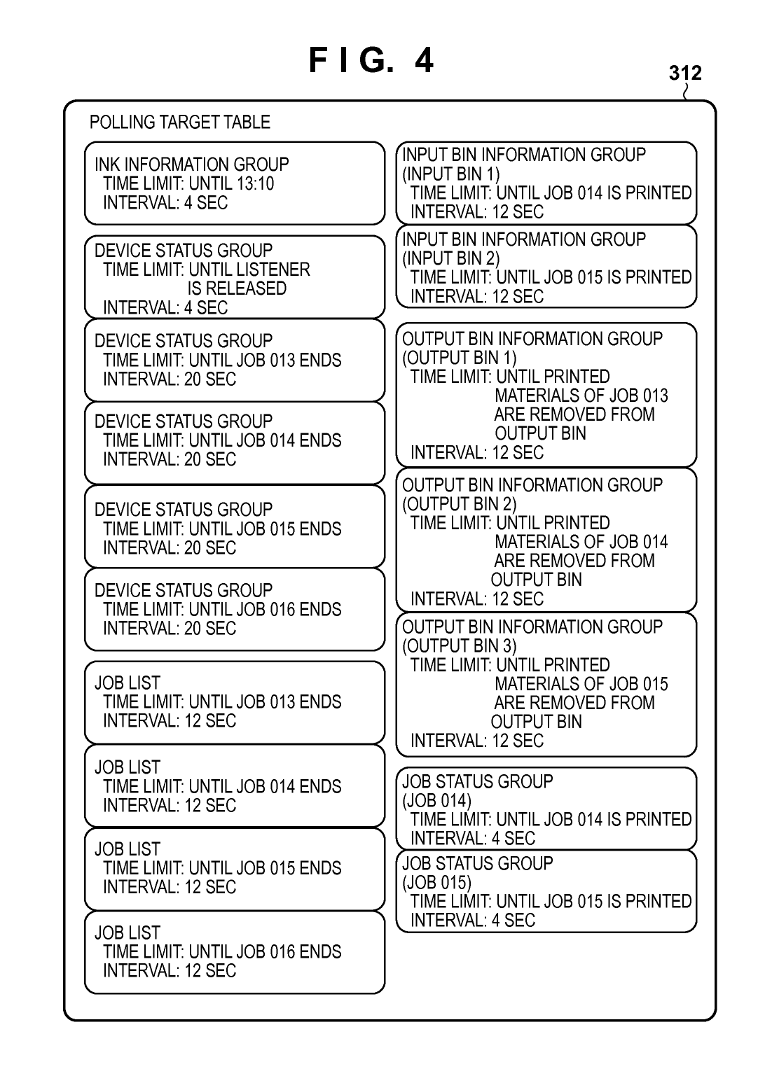

FIG. 4 shows a configuration example of the polling target table 312. In the polling target table 312, status items to be acquired from the printer 103 and their conditions are registered for respective groups (to be referred to as status groups hereinafter). For each of a plurality of status groups, an acquisition time limit until polling is aborted and an acquisition interval of a status (to be referred to as a polling interval hereinafter) are registered. For example, “ink information group” is registered as a status group, and “time 13:10” as a status acquisition time limit and “4 sec” as a polling interval are registered. This setting indicates that status items of “ink information group” are acquired from the printer 103 at 4-sec intervals until time reaches 13:10.

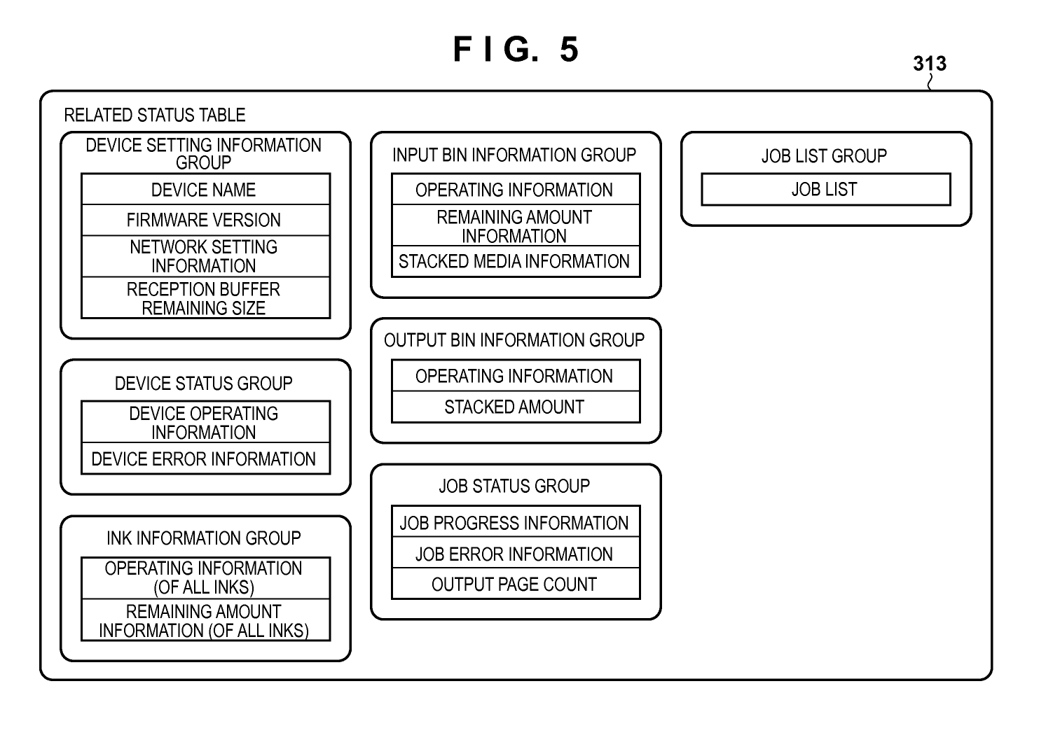

The status groups registered in the polling target table 312 further include status items indicated by a related status table 313 shown in FIG. 5. Status items to be acquired in this embodiment include device status information related to a device such as the printer 103 and job status information related to a print job executed by the device. The related status table 313 groups status items related to respective status groups. For example, in “ink information group”, “operating information of all inks” and “remaining amount information of all inks” are grouped. At this time, when “ink information group” is registered in the polling target table 312, the status acquisition unit 301 acquires status items of operating statuses and ink remaining amount information of all ink types from the printer 103. In this case, all the ink types correspond to, for example a black ink, cyan ink, magenta ink, and yellow ink in a printer which handles four types of inks. Also, the operating status for each ink type includes statuses such as “normal operation”, “warning generated”, and “error status”.

The status acquisition unit 301 analyzes the real status data 311 acquired from the device, and sends a status change notification to respective modules based on the analysis result. This status analysis notification may be sent even when statuses are left unchanged.

A status cache data generation unit 302 generates status cache data 314 from the real status data 311 and information of a job management table 315 managed by a job management unit 306. The status cache data 314 is cache data related to statuses held in a cache, and its role will be described later together with the processing sequences.

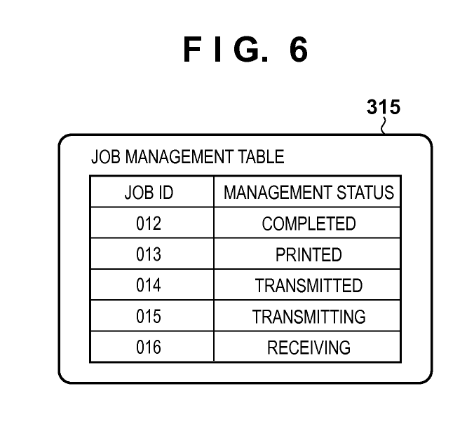

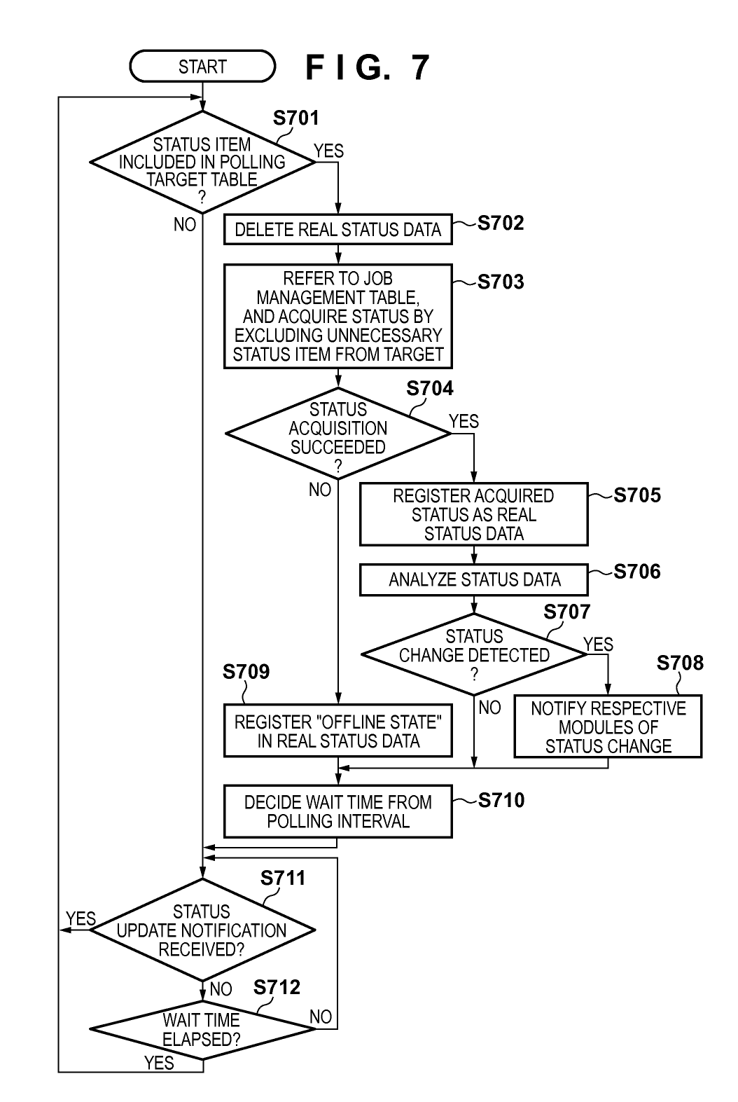

The job management table 315 includes information required to manage job control in the print server 102, and is held in a format shown in FIG. 6. The job management table 315 holds job IDs assigned to print jobs, and management statuses of the print jobs in the print server 102 and printer 103 in association with each other. A job ID is an ID used to manage each print job, and the job management unit 306 gives a value unique to each print job. This print job ID is issued in response to a print instruction from the client PC 101. A management status of a print job includes “receiving”, “transmitting”, “transmitted”, “printed”, “completed”, “canceling”, “canceled”, and the like.

The management status “receiving” indicates a state after a print instruction is received from the client PC 101 and before that print instruction is transmitted to the printer 103. “Transmitting” indicates a state in which a print job begins to be issued to the printer 103, and print data is being transmitted to the printer 103. “Transmitted” indicates a state after transmission of print data is complete and before print processing in the printer 103 is completed. “Printed” indicates a state after print processing in the printer 103 is complete and before printed materials are removed from an output bin. “Completed” indicates a state in which all printed materials are removed. “Canceling” indicates a state in which cancel processing is in progress when a print job is canceled in the middle of processing. “Canceled” indicates a state in which cancel processing is complete. Although not clearly described in FIG. 6, each print job is linked with various kinds of information of the print job such as a print job name, an issuing operator, print settings, an input bin to be used, and media to be used.

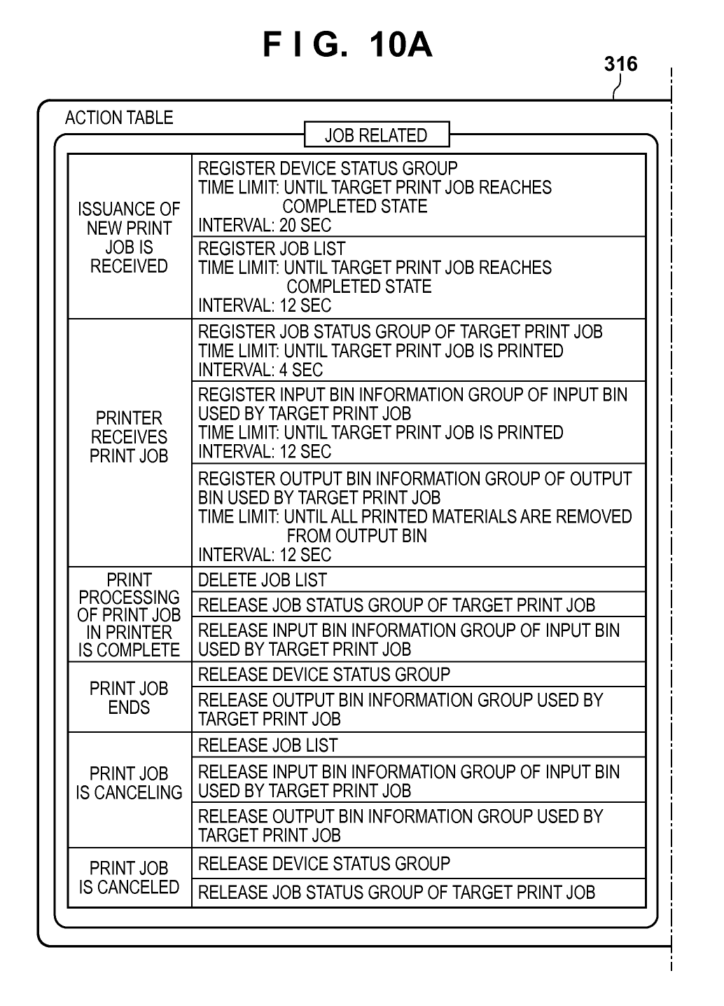

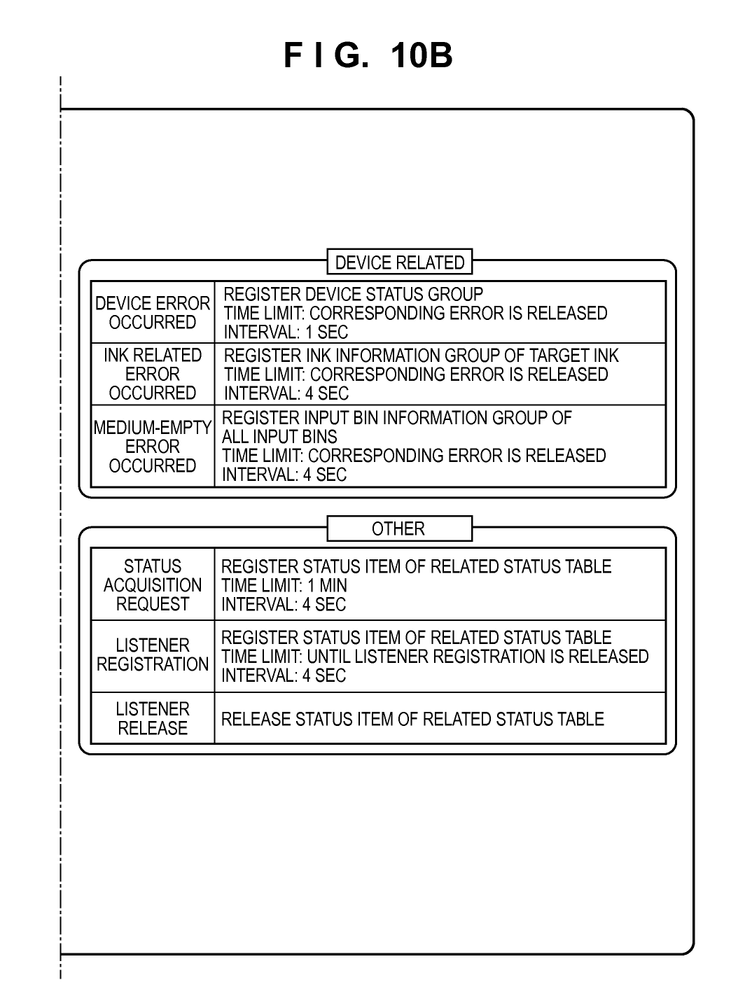

A polling target table management unit 303 manages the polling target table 312, and registers and deletes status items in the polling target table 312 according to an action table 316. Details of the action table 316 will be described later with reference to FIGS. 10A and 10B, and defines events and operations of the polling target table 312 upon occurrence of the events.

A status acquisition request reception unit 304 receives a status acquisition request from the client PC 101. Then, the status acquisition request reception unit 304 refers to the status cache data 314 generated by the status cache data generation unit 302, and returns information of corresponding status items to the client PC 101.

A listener processing unit 305 notifies the client PC 101 of a change in information of the status cache data 314 for a status item designated by the client PC 101 when that information has changed. When the client PC 101 issues a listener registration release request, the listener processing unit 305 releases listener registration of a designated status item, and does not send any change notification to the client PC 101 even when a status change occurs after the registration is released.

The job management unit 306 receives a print instruction and a control instruction of a print job such as a suspend instruction from the client PC 101, converts print data corresponding to the print job into an interpretable format of the printer 103, and transfers it to the printer 103. Also, the job management unit 306 updates the job management table 315 in correspondence with progress statuses of print jobs in the print server 102 and printer 103, thereby managing the respective print jobs.

(Status Acquisition Unit 301)

A status data update method in the print server 102 will be described below. FIG. 7 is a flowchart associated with update processing of status data by the status acquisition unit 301. This processing is executed when the CPU 201 included in the print server 102 reads out a program stored in the HD 205 or the like.

The status acquisition unit 301 refers to the polling target table 312 to confirm if there are status items to be acquired (step S701). If there is no status item as a polling target (NO in step S701), the process advances to step S711. If there are status items as polling targets (YES in step S701), the status acquisition unit 301 deletes the held real status data 311 (previously acquired status data) (step S702). After that, the status acquisition unit 301 acquires status items described in the polling target table 312 from the device (step S703). At this time, the status acquisition unit 301 refers to the job management table 315, and does not acquire any status item of a “receiving” print job if “job status group” is registered in the polling target table 312. Since the “receiving” print job is not transferred to the printer 103, “job status group” information of the “receiving” print job does not exist in the printer 103. Also, the status acquisition unit 301 does not acquire status items of “printing”, “completed”, and “canceled” print jobs from the printer 103 even when their “job status groups” are registered in the polling target table 312. As will be described in detail later, since pieces of their “job status group” information have already been held by the job management unit 306, the status acquisition unit 301 does not acquire their status items from the printer 103. Note that a method of managing information indicating whether or not to acquire status items of these “job status groups” from the printer 103 using a table independent from the job management table 315 may be adopted.

The status acquisition unit 301 checks whether or not statuses can be successfully acquired from the printer 103 in step S703 (step S704). If statuses can be successfully acquired (YES in step S704), the status acquisition unit 301 registers the acquired status data as real status data 311 (step S705). After that, the status acquisition unit 301 analyzes the real status data 311 (step S706). Then, the status acquisition unit 301 judges as a result of analysis whether or not the statuses have changed (step S707). If the statuses have not changed (NO in step S707), the process advances to step S710. If the statuses have changed (YES in step S707), the status acquisition unit 301 notifies other modules of the status changes (step S708). Then, the process advances to step S710.

On the other hand, if the statuses cannot be acquired (NO in step S704), the status acquisition unit 301 judges an offline state with the device, and registers the offline state in the real status data 311 (step S709). Then, the process advances to step S710.

Next, the status acquisition unit 301 refers to a polling interval described in the polling target table 312, and acquires a wait time (step S710).

The status acquisition unit 301 confirms in step S711 whether or not it receives a status update notification from another module. If a status update notification is received (YES in step S711), the process returns to step S701, and the status acquisition unit 301 executes status update processing again. If no status update notification is received (NO in step S711), the process advances to step S712, and the status acquisition unit 301 confirms whether or not the wait time acquired in step S710 has elapsed. If the wait time has not elapsed yet (NO in step S712), the process returns to step S711, and the status acquisition unit 301 repeats to confirm whether or not a status update notification is received and whether or not the wait time has elapsed. If the wait time has elapsed (YES in step S712), the process returns to step S701.

(Status Cache Data Generation Unit 302)

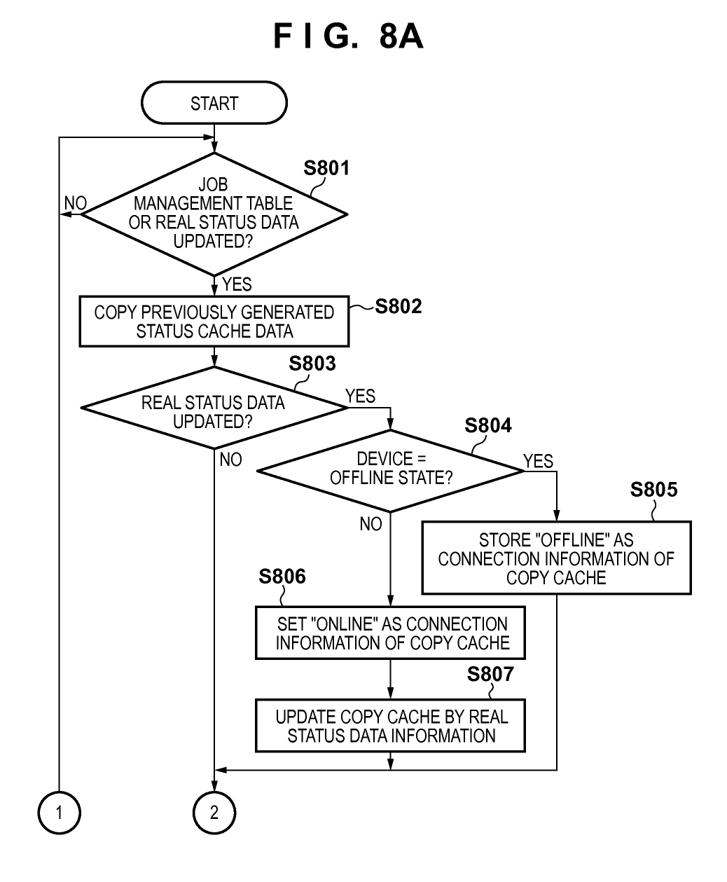

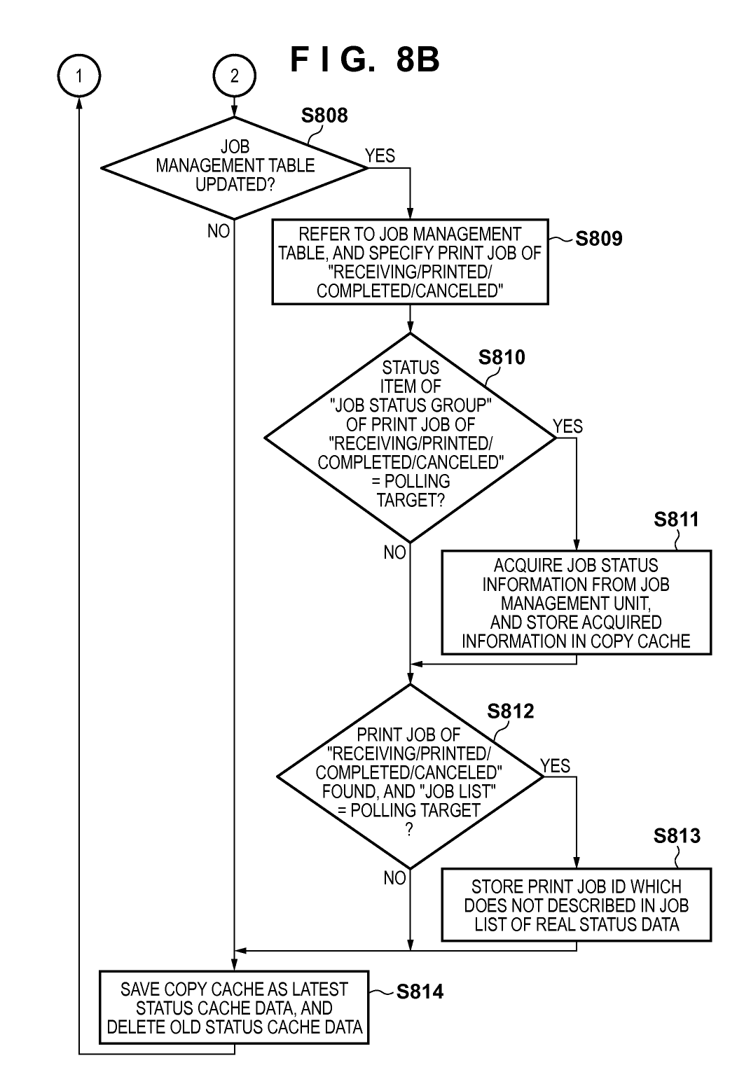

FIGS. 8A and 8B show processing of the status cache data generation unit 302. This processing is executed when the CPU 201 included in the print server 102 reads out a program stored in the HD 205 or the like.

The status cache data generation unit 302 confirms whether or not the job management table 315 or real status data 311 has been updated (step S801). Whether or not the table or data has been updated can be determined by confirming a notification at an update timing or a data update date and time. If neither the table nor data is updated (NO in step S801), the process returns to step S801, and the control waits until one of the table and data is updated. If one or both of the job management table 315 and real status data 311 have been updated (YES in step S801), the status cache data generation unit 302 generates a copy of the previously generated status cache data 314 in step S802. This generated copy will be referred to as “copy cache” hereinafter. At this time, when there is no previously generated status cache data 314, the status cache data generation unit 302 generates an empty copy cache in which no status information is registered.

Next, the status cache data generation unit 302 confirms whether or not the real status data 311 has been updated (step S803). Whether or not the data has been updated can be determined by confirming a notification at an update timing or a data update date and time. If the real status data 311 has not been updated (NO in step S803), the process advances to step S808. If the real status data 311 has been updated (YES in step S803), the status cache data generation unit 302 refers to the real status data 311 to judge in step S804 whether or not the device is in an offline state. The offline state is confirmed using information registered by the status acquisition unit 301 in the real status data 311 in step S704 in FIG. 7. If the device is in the offline state (YES in step S804), the status cache data generation unit 302 stores “offline” in a connection information item of the copy cache (step S805). After that, the process advances to step S808.

If the device is in an online state (NO in step S804), the status cache data generation unit 302 stores “online” in the connection information item of the copy cache (step S806). Then, the status cache data generation unit 302 updates information of the copy cache by that of the real status data 311 (step S807). At this time, the status cache data generation unit 302 may delete a status item which is not included in the real status data 311 but is included in only the copy cache, or such status item may be left. After that, the process advances to step S808.

The status cache data generation unit 302 confirms in step S808 whether or not information of the job management table 315 has been updated. Whether or not the information has been updated can be determined by confirming a notification at an update timing or a data update date and time. If the information has not been updated (NO in step S808), the process advances to step S814. If the information of the job management table 315 has been updated (YES in step S808), the status cache data generation unit 302 specifies print jobs of “receiving”, “printed”, “completed”, and “canceled” statuses from the job management table 315 (step S809). Furthermore, the status cache data generation unit 302 checks in step S810 with reference to the polling target table 312 whether or not that table includes “job status group” items associated with the print jobs of the “receiving”, “printed”, “completed”, and “canceled” statuses. If the print jobs of the above statuses are included (YES in step S810), the status cache data generation unit 302 stores “job status group” information of these print jobs held by the job management unit 306 in the copy cache (step S811).

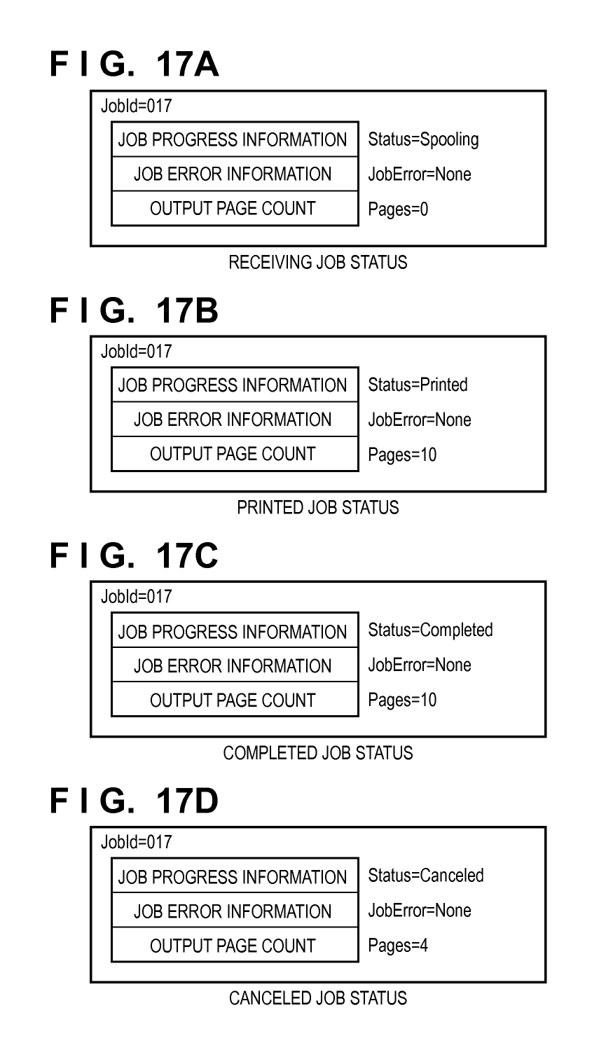

Note that the job management unit 306 holds “job status group” information in association with print jobs of “receiving”, “printed”, “completed”, and “canceled” statuses. Details of job status group information will be described later with reference to FIGS. 17A to 17D.

Furthermore, the status cache data generation unit 302 checks in step S812 whether or not the job management table 315 includes print jobs of “receiving”, “printed”, “completed”, and “canceled” statuses, and a “job list” is registered in the polling target table 312. If the print jobs of the statuses are included and the “job list” is registered (YES in step S812), the status cache data generation unit 302 adds job IDs of the print jobs of the statuses to the “job list” of the copy cache (step S813).

In step S814, the status cache data generation unit 302 registers the copy cache generated in step S802 as the latest status cache data 314, and deletes the old status cache data. The process returns to step S801, and the status cache data generation unit 302 waits until the job management table 315 or real status data 311 is updated.

(Polling Target Table Management Unit 303)

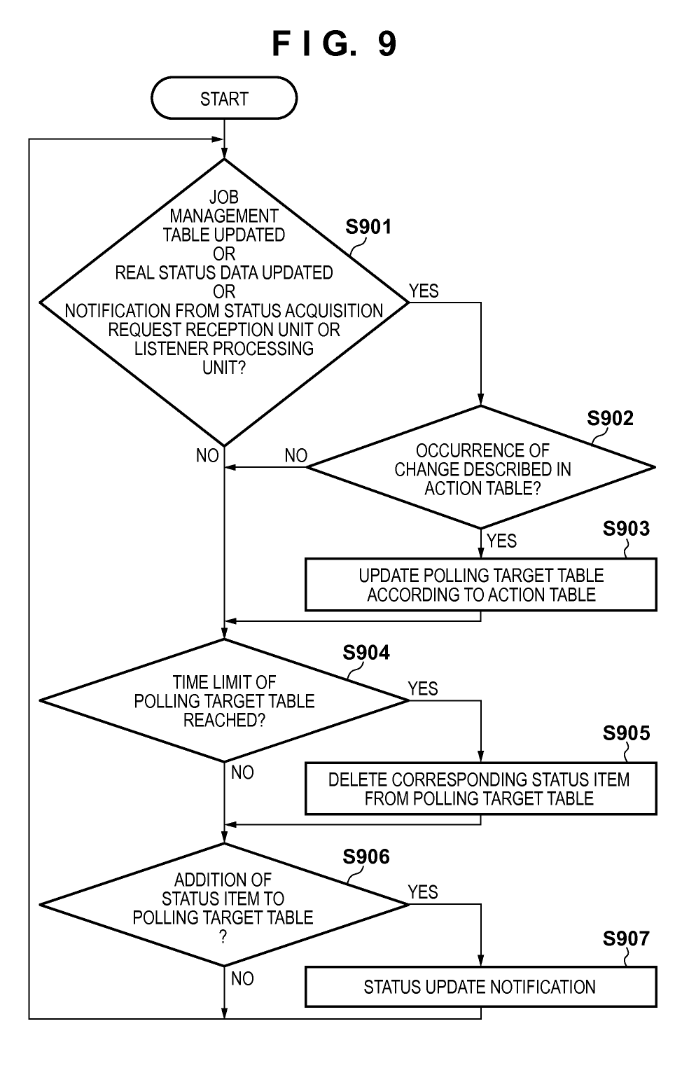

The sequence of the polling target table management unit 303 will be described below with reference to FIG. 9. This processing is executed when the CPU 201 included in the print server 102 reads out a program stored in the HD 205 or the like.

The polling target table management unit 303 confirms in step S901 whether or not the job management table 315 is updated, the real status data 311 is updated, or a notification from the status acquisition request reception unit 304 or listener processing unit 305 is received. If the table or data is not updated or no notification is received (NO in step S901), the process advances to step S904.

If the table is updated or a notification from the processing unit is received (YES in step S901), the polling target table management unit 303 confirms whether or not a change defined in the action table 316 shown in FIGS. 10A and 10B has taken place (step S902). If a change described in the action table 316 has taken place (YES in step S902), the polling target table management unit 303 updates the polling target table 312 according to information defined in the action table 316 (step S903).

The action table 316 defines status change events or notification events and change processing of the polling target table 312 when these events have occurred, as shown in FIGS. 10A and 10B. For example, assume that it is judged with reference to the job management table 315 that “issuance of a new print job is received” in FIGS. 10A and 10B. In this case, pieces of information “a device status group is acquired at 20-sec intervals until a target print job reaches a completed state” and “a job list is acquired at 12-sec intervals until a target print job reaches a completed state” are registered in the polling target table 312.

The polling target table management unit 303 confirms in step S904 with reference to the polling target table 312 if a time limit of each registered status item has been reached. The time limit is judged based on the job management table 315 or a status change from the status acquisition unit 301. If a set time limit of a given status item has reached (YES in step S904), the polling target table management unit 303 deletes the corresponding status item from the polling target table 312 (step S905). For example, the aforementioned “device status group” and “job list” are deleted from the polling target table 312 when “a target print job reaches a completed state”.

The polling target table management unit 303 confirms in step S906 whether or not a new status item is added to the polling target table 312. If a new status item is added by the process in step S903 (YES in step S906), the polling target table management unit 303 notifies the status acquisition unit 301 to acquire a real status (step S907). After that, the process returns to step S901, and the polling target table management unit 303 repeats the aforementioned series of operations.

(Status Acquisition Sequence)

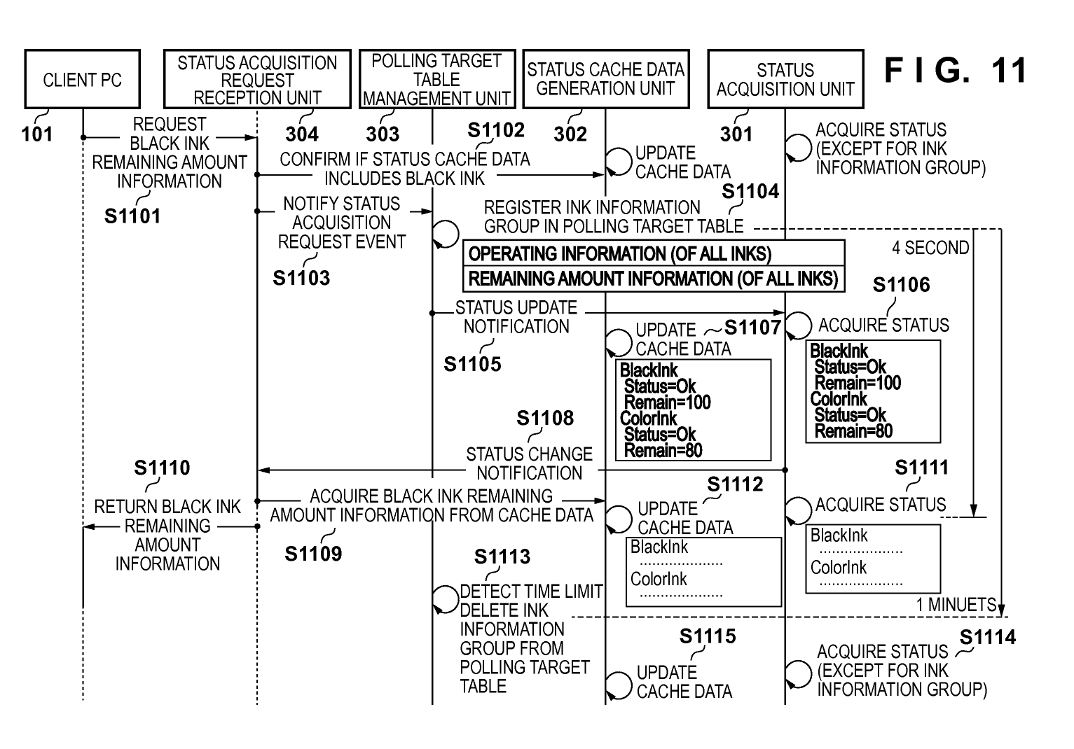

The sequence executed when the client PC 101 issues a status acquisition request to the print server 102 will be described below. In this case, processing of an example in which a “black ink remaining amount” information request is issued will be described below with reference to FIG. 11.

When the client PC 101 issues a “black ink remaining amount” information request to the print server 102, the status acquisition request reception unit 304 of the print server 102 receives that request (step S1101). The status acquisition request reception unit 304 confirms with reference to the status cache data 314 whether or not “black ink remaining amount” information is included (step S1102). At this time, if the status cache data 314 includes the “black ink remaining amount” information, information of the status cache data 314 is returned to the client PC 101. In this case, processing executed when the status cache data 314 does not include any “black ink remaining amount” information will be described below.

The status acquisition request reception unit 304 notifies the polling target table management unit 303 of a status acquisition request event (step S1103). The polling target table management unit 303 refers to the status acquisition request event in the action table 316 shown in FIGS. 10A and 10B, and registers an “ink information group” as a related status of the “black ink remaining amount” information in the polling target table 312 (step S1104). After that, the polling target table management unit 303 sends a status update notification to the status acquisition unit 301 (step S1105).

Upon reception of the status update notification, the status acquisition unit 301 acquires a status from the printer 103. At this time, the status acquisition unit 301 acquires information of the “ink information group” registered in the polling target table 312, that is, “operating information of all inks” and “remaining amount information of all inks” from the printer 103 (step S1106). After the real status data 311 is updated, the status cache data generation unit 302 generates status cache data 314 including the “ink information group” (step S1107).

The status acquisition request reception unit 304 receives a status change (since “ink information” has been acquired in this case) from the status acquisition unit 301 (step S1108). Thus, the status acquisition request reception unit 304 acquires “black ink remaining amount” information from the status cache data 314 (step S1109). Then, the status acquisition request reception unit 304 notifies the client PC 101 of the acquired information (step S1110).

On the other hand, in step S1104, to acquire “ink information group” information at polling intervals of 4 sec until an elapse of 1 min is registered in the polling target table 312. For this reason, the status acquisition unit 301 acquires “ink information group” information from the printer 103 in step S1111 as a timing after an elapse of 4 sec after step S1104. Then, the status cache data generation unit 302 saves the acquired information also in the status cache data 314 (step S1112).

After that, the status acquisition unit 301 continuously acquires “ink information group” information from the printer 103 at predetermined intervals. After an elapse of 1 min after step S1104, the polling target table management unit 303 deletes the “ink information group” from the polling target table 312 (step S1113). For this reason, in the subsequent status acquisition processing of the status acquisition unit 301, the “ink information group” is not acquired from the printer 103 (step S1114). Then, the status cache data generation unit 302 deletes the “ink information group” also from the status cache data 314 (step S1115).

(Listener Registration/Release Sequence)

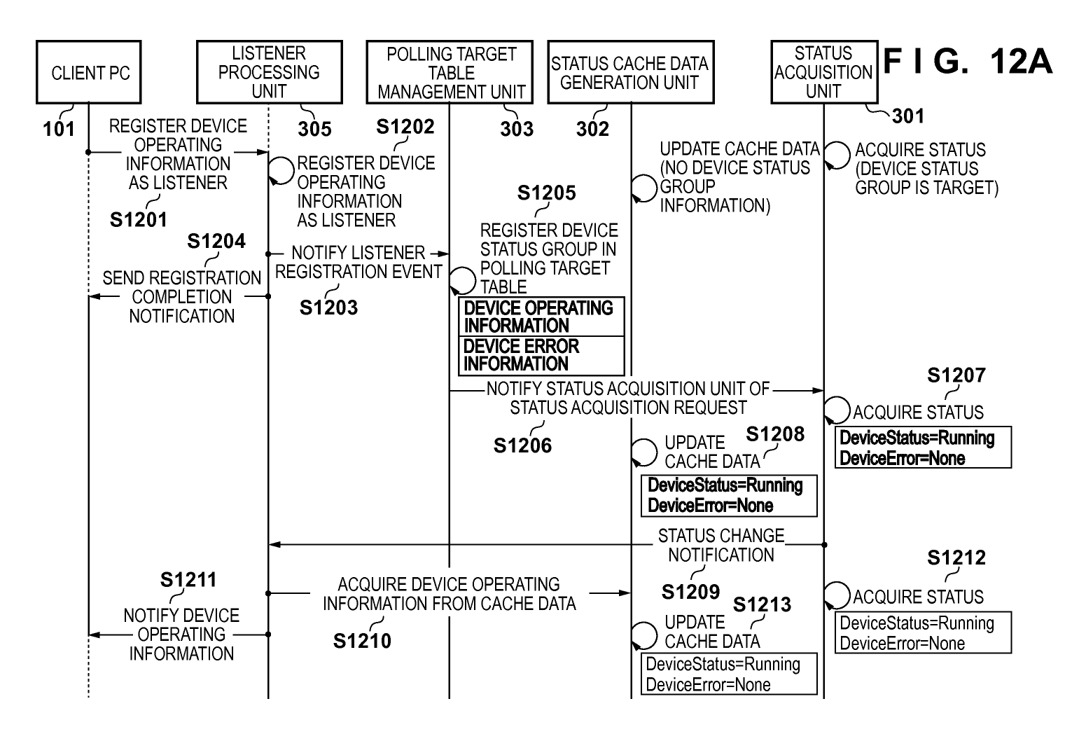

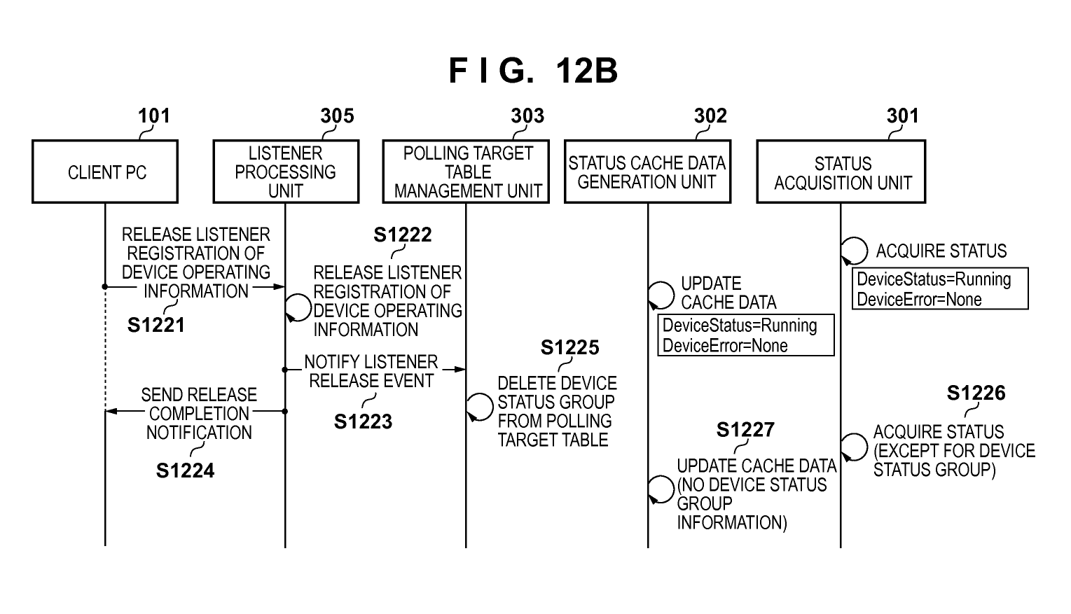

The listener registration/release sequence will be described below with reference to FIGS. 12A and 12B. FIGS. 12A and 12B exemplify a case in which the client PC 101 registers/releases “device operating information” as a listener. FIG. 12A shows the listener registration related sequence, and FIG. 12B shows the listener release related sequence.

When the client PC 101 notifies the print server 102 of listener registration of “device operating information”, the listener processing unit 305 of the print server 102 receives that notification (step S1201). The listener processing unit 305 holds information indicating that the “device operating information” is registered as a listener (step S1202). Then, the listener processing unit 305 notifies the polling target table management unit 303 of a listener registration event (step S1203). Also, the listener processing unit 305 sends a listener registration completion notification to the client PC 101 (step S1204).

The polling target table management unit 303 refers to a listener registration event in the action table 316, and registers a “device status group” as a related status group in the polling target table 312 (step S1205). In this case, items registered in the polling target table 312 include “device operating information” and “device error information”. After that, the polling target table management unit 303 sends a status update notification to the status acquisition unit 301 (step S1206).

Upon reception of the status update notification from the polling target table management table 303, the status acquisition unit 301 acquires statuses from the printer 103. At this time, the status acquisition unit 301 acquires “device status group” information registered in the polling target table 312 (step S1207). After the real status data 311 is updated, the status cache data generation unit 302 generates status cache data 314 including the “device status group” information (step S1208).

The status acquisition request reception unit 304 receives status changes (since the “device status group” information has been acquired in this case) from the status acquisition unit 301 (step S1209). Then, the listener processing unit 305 acquires “device operating information” information from the status cache data 314 (step S1210). At this time, when the acquired information has changed, the listener processing unit 305 notifies the client PC 101 of that information (step S1211).

On the other hand, in step S1205, to acquire the “device status group” information at 4-sec intervals is registered in the polling target table 312. For this reason, the polling target table management unit 303 acquires the “device status group” information from the printer 103 at 4-sec intervals after the process in step S1205 (step S1212). Then, the status cache data generation unit 302 reflects the acquired information to the status cache data 314 (step S1213). At this time, every time the “device operating information” of the status cache data 314 has changed, the listener processing unit 305 notifies the client PC 101 of that change.

When the client PC 101 sends a listener release notification to the print server 102, the listener processing unit 305 of the print server 102 receives that notification (step S1221). The listener processing unit 305 discards the registered information of the “device operating information” held in step S1202 (step S1222). Then, the listener processing unit 305 notifies the polling target table management unit 303 of a listener release event (step S1223). Also, the listener processing unit 305 sends a listener release completion notification to the client PC 101 (step S1224).

The polling target table management unit 303 refers to a listener release event in the action table 316, and deletes the “device status group” as a target item from the polling target table 312 (step S1225). After that, the status acquisition unit 301 does not acquire any “device status group” information at the next status acquisition timing (step S1226). After the real status data 311 is updated, the status cache data generation unit 302 generates status cache data 314 which does not include any “device status group” information (step S1227).

(Print Job Processing Sequence 1)

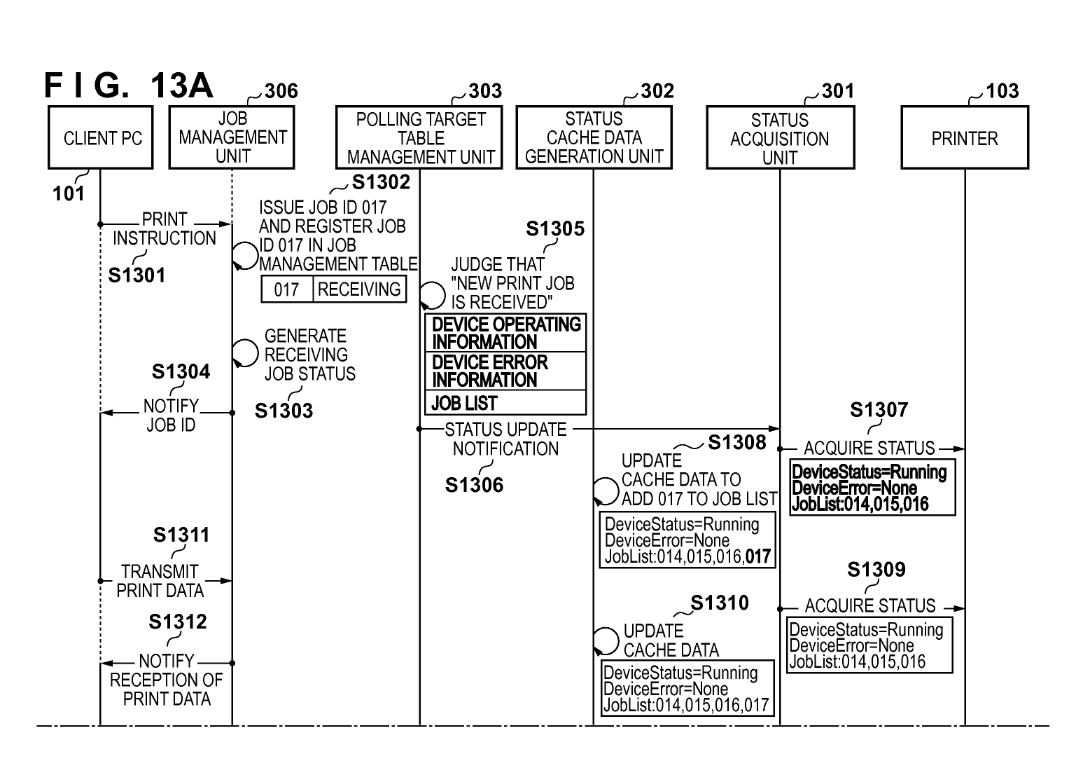

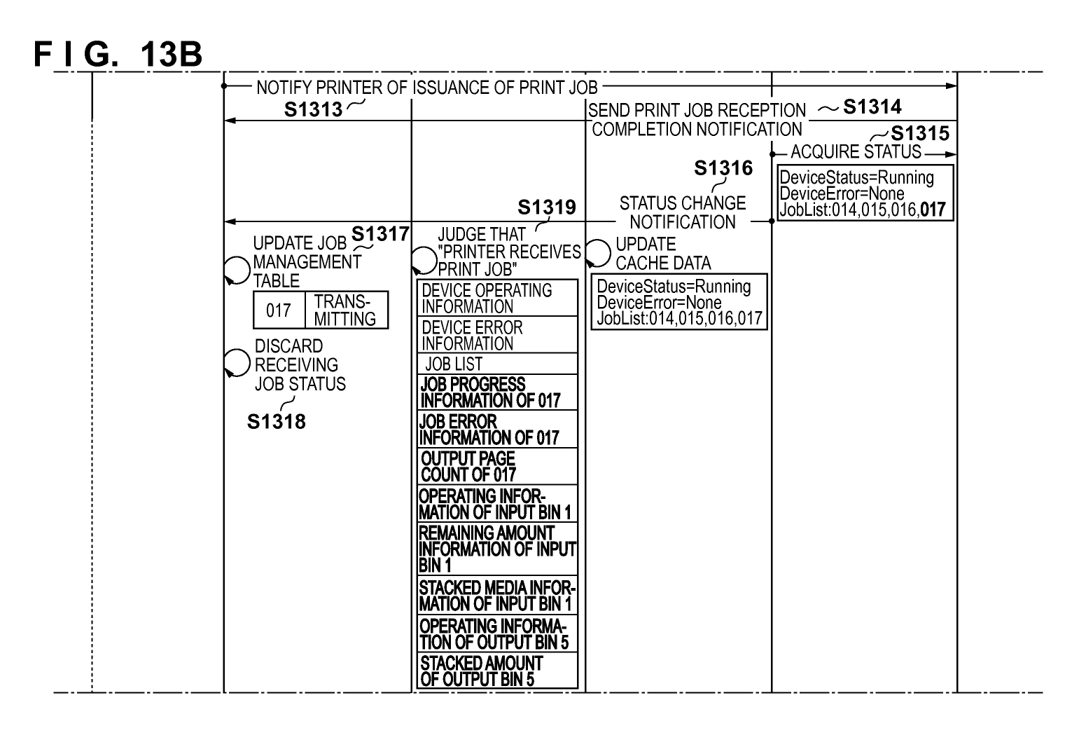

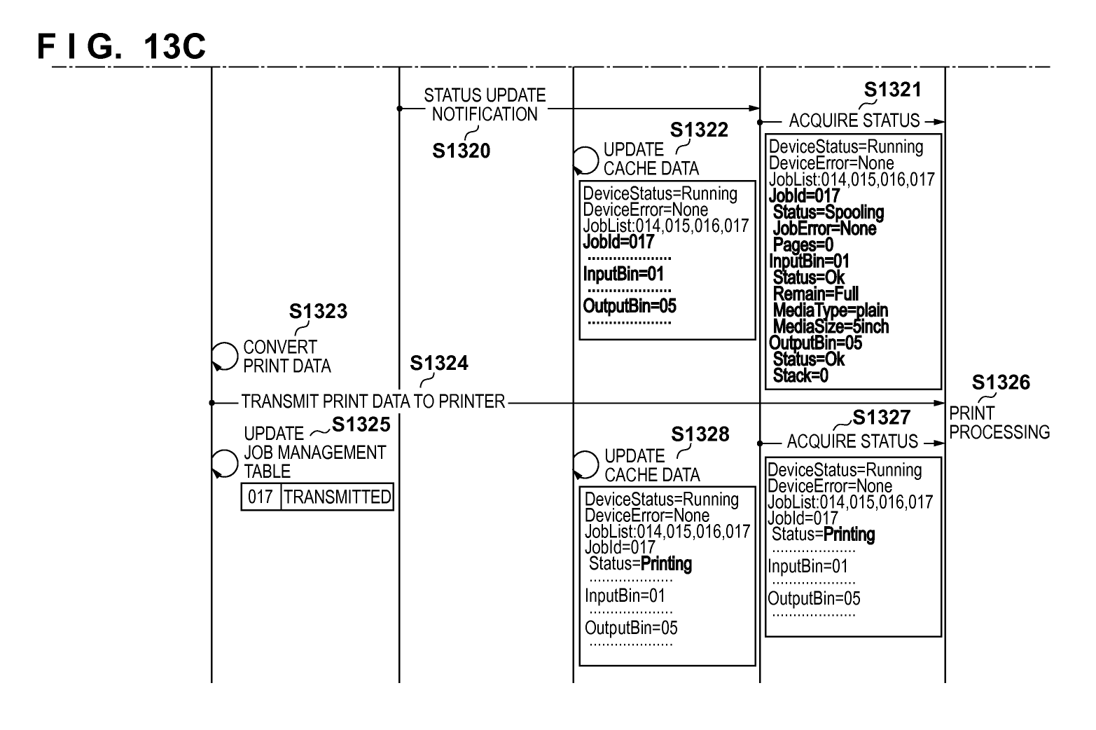

Processing executed upon reception of a print instruction from the client PC 101 will be described below with reference to FIGS. 13A to 13C.

When the client PC 101 issues a print instruction to the print server 102, the job management unit 306 of the print server 102 receives that request (step S1301). Upon reception of the print instruction, the job management unit 306 issues a job ID, and registers it in the job management table 315 (step S1302). In this case, a job ID of a print job is “017”, and the corresponding print job will be described as “print job 017”. At this time, management information of the print job is registered as “receiving”. Also, the job management unit 306 registers setting information received as the print instruction in association with the print job 017. Furthermore, the job management unit 306 generates a “receiving job status” shown in FIG. 17A (step S1303). In this “receiving job status”, “Spooling” is set in “job progress information”, “None (no error)” is set in “job error information”, and “0” is set in “output page count”. Then, the job management unit 306 notifies the client PC 101 of the job ID, thus notifying the client PC 101 that the print instruction is received (step S1304).

On the other hand, the polling target table management unit 303 refers to the action table 316 since the new receiving print job 017 is registered in the job management table 315. Then, the polling target table management unit 303 registers “device status group” and “job list” in the polling target table 312 (step S1305). In this case, as shown in FIG. 5, items of the “device status group” correspond to “device operating information” and “device error information”. Then, the polling target table management unit 303 sends a status update notification to the status acquisition unit 301 (step S1306).

The status acquisition unit 301 newly acquires “device status group” and “job list” from the printer 103 in accordance with the received status update notification (step S1307). In this case, information of “Running” is acquired for “device operating information (DeviceStatus)”. Likewise, “None” is acquired for “device error information (DeviceError)”, and pieces of information of job IDs “014”, “015”, and “016” are acquired as “job list (JobList)”.

When the real status data 311 is updated when the status acquisition unit 301 acquires statuses, the status cache data generation unit 302 generates status cache data 314 (step S1308). As described above in step S808 in FIG. 8B, the job ID “017” is added to the “job list” information acquired in step S1307.

Since the polling interval=12 sec is set in step S1305, the real status data 311 and status cache data 314 are updated as in steps S1307 and S1308 at 12-sec intervals after step S1305 (steps S1309 and S1310).

Although not shown in FIGS. 13A to 13C, when job status information of the print job 017 is acquired from the client PC 101 between steps S1309 and S1310, it is processed as follows. That is, as described above using FIGS. 8A and 8B, the status cache data generation unit 302 adds the “receiving job status” generated in step S1303 to the status cache data 314. Then, the status cache data generation unit 302 notifies the client PC 101 of the added information.

Upon reception of the job ID from the print server 102 in step S1304, the client PC 101 transmits print data to the print server 102 (step S1311). As a response to the print data, the job management unit 306 notifies the client PC 101 that the print data is received (step S1312). Furthermore, the job management unit 306 notifies the printer 103 of issuance of the print job (step S1313).

When the printer 103 receives the print job from the print server 102, the printer 103 sends a print job reception completion notification to the job management unit 306 of the print server 102 (step S1314). Since the printer 103 adds the received print job to the job list information, the status acquisition unit 301 executes status acquisition processing after the print job is received, and acquires job list information including the print job 017 (step S1315). The status acquisition unit 301 sends a status change notification to the job management unit 306 (step S1316).

Upon reception of the status change notification from the status acquisition unit 301, the job management unit 306 changes information of the job ID “017” in the job management table 315 to “transmitting” (step S1317). Furthermore, the job management unit 306 discards the “receiving job status” generated in step S1303 (step S1318).

In response to a change of the job management table 315 in step S1317, the polling target table management unit 303 judges that the printer 103 receives the print job. Then, the polling target table management unit 303 refers to the action table 316, and registers “job status group”, “input bin information”, and “output bin information” of the print job 017 in the polling target table 312 (step S1319). Furthermore, the polling target table management unit 303 sends a status update notification to the status acquisition unit 301 (step S1320). In response to this notification, the status acquisition unit 301 acquires pieces of status information registered in the polling target table 312 from the printer 103 (step S1321). Furthermore, the status cache data generation unit 302 stores these pieces of information also in the status cache data 314 (step S1322).

After that, the job management unit 306 converts the print data received in step S1311 into an interpretable format of the printer 103 (step S1323). Then, the job management unit 306 transmits the converted print data to the printer 103 (step S1324). Upon completion of transmission of the print data, the job management unit 306 updates the status of the print job 017 in the job management table 315 to “transmitted” (step S1325).

Upon reception of the print data in step S1324, the printer 103 starts print processing according to the received print data (step S1326).

On the other hand, since the polling target table 312 is changed to acquire a status at 4-sec intervals at the timing of step S1319, the status acquisition unit 301 acquires a status at 4-sec intervals after step S1319 (step S1327). In response to this, the status cache data generation unit 302 updates the status cache data 314 (step S1328).

(Print Job Processing Sequence 2)

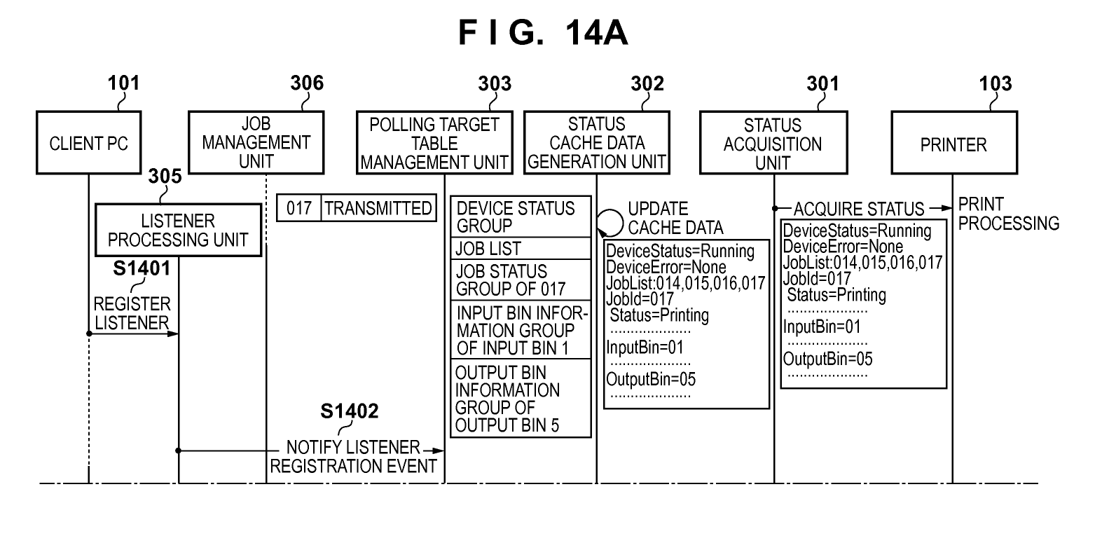

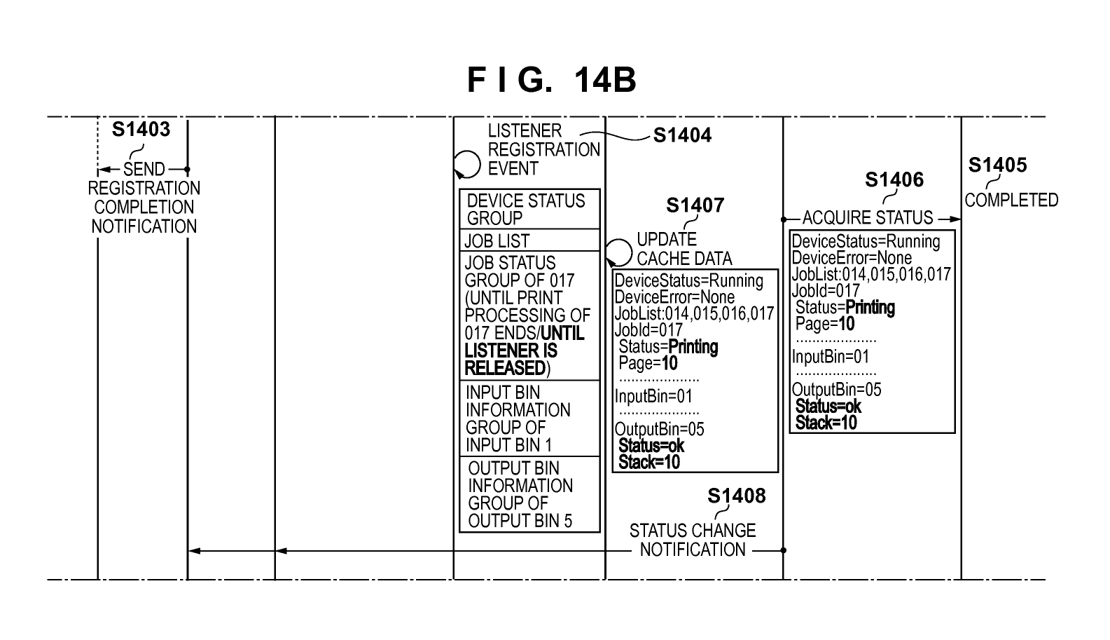

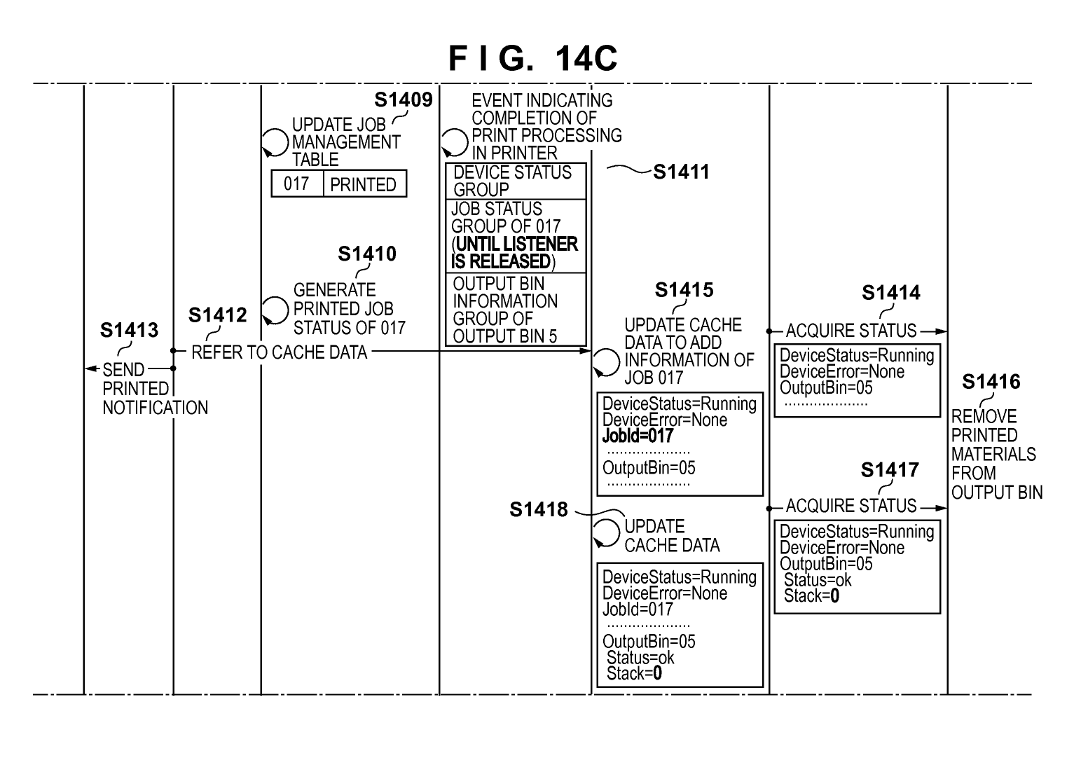

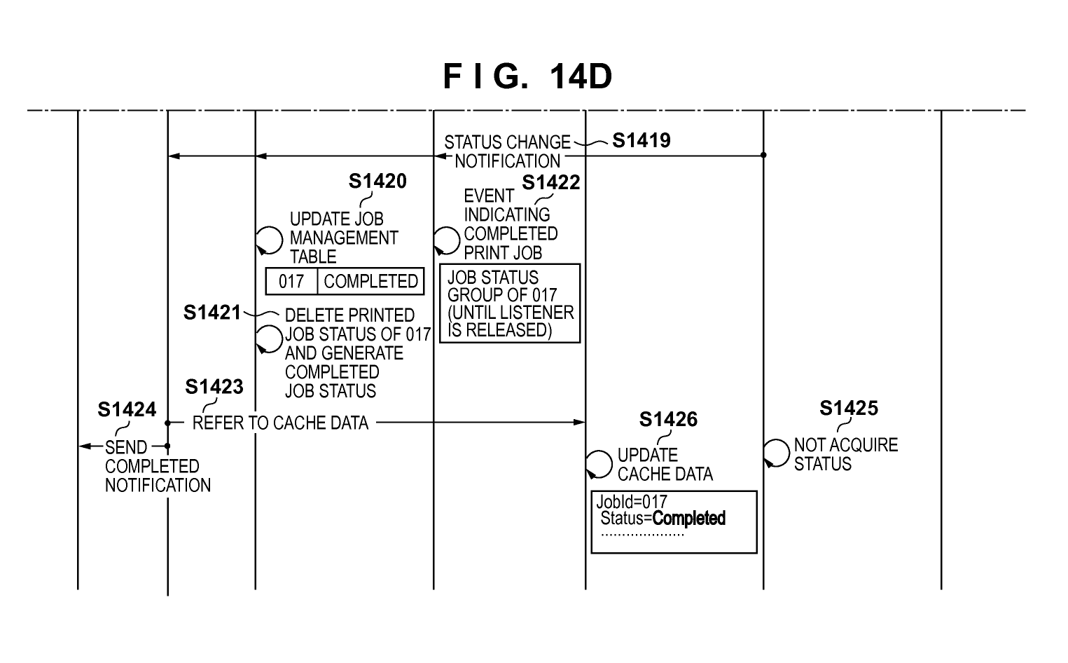

The print job sequence after FIGS. 13A to 13C will be described below with reference to FIGS. 14A to 14D. Furthermore, in this example, “job progress information” of the print job 017 is registered as a listener, and every time the “job progress information” of the print job has changed, the client PC 101 is notified of that change.

In step S1401, the client PC 101 issues a listener registration instruction, and the listener processing unit 305 of the print server 102 receives that instruction. Then, the listener processing unit 305 notifies the polling target table management unit 303 of a listener registration event (step S1402). The listener processing unit 305 sends a listener registration completion notification to the client PC 101 (step S1403). After that, the listener processing unit 305 monitors a change in “job progress information” of the print job 017 included in the status cache data 314.

Upon reception of the listener registration event in step S1402, the polling target table management unit 303 registers “job status group” information of the print job 017 in the polling target table 312 as the listener registration event (step S1404). However, since the “job status group” of the print job 017 has already been registered at the print job reception timing (step S1319 in FIG. 13B) of the printer 103, time limit information (“until listener registration is released”) is additionally registered.

Upon completion of the print processing of the print job 017 in the printer 103 (step S1405), the status acquisition unit 301 acquires that information (step S1406). Then, the status cache data generation unit 302 updates the status cache data 314 (step S1407). The status acquisition unit 301 sends a status change notification to the job management unit 306 and listener processing unit 305 (step S1408).

Upon reception of the status change notification, the job management unit 306 changes the management information of the print job 017 in the job management table 315 to “printed” (step S1409). Furthermore, the job management unit 306 refers to the information of the status cache data 314, and generates and holds a “printed job status” of the print job 017, as shown in FIG. 17B (step S1410).

After the job management table 315 is updated in step S1409, the polling target table management unit 303 judges that the print processing in the printer 103 is complete. As a result of this judgment, the polling target table management unit 303 refers to the action table 316. Then, the polling target table management unit 303 deletes the “job list”, the “job status group” of the print job 017, and “input bin information group” of input bin 1 to be used from the polling target table 312 (step S1411). However, the “job status group” of the print job 017 is registered as a listener in step S1404. For this reason, only the time limit information is updated, and the “job status group” is not deleted from the polling target table 312.

Upon reception of the status change notification in step S1408, the listener processing unit 305 refers to the “job progress information” of the status cache data 314, and detects that the “job progress information” of the print job 017 has changed to “printed” (step S1412). After that, the listener processing unit 305 notifies the client PC 101 of that information (step S1413).

The status acquisition unit 301 acquires statuses in step S1414. At this time, since the print job 017 is complete, the status acquisition unit 301 does not acquire the “job status group” information of the print job 017 registered in the polling target table 312 from the information of the job management table 315, as described above using FIG. 7. Upon generation of the status cache data 314 from the real status data 311 acquired in step S1414, the status cache data generation unit 302 adds the “printed job status” held by the job management unit 306 in step S1410 to the status cache data 314 (step S1415).

After that, the operator removes all printed materials of the print job 017 from the printer 103 (step S1416). Then, “stacked amount information” of output bin 5 in the real status data 311 becomes “0” in step S1417. Whether or not printed materials are removed is detected by, for example, a sensor included in the printer 103. In response to this, the status cache data generation unit 302 also updates the status cache data 314 (step S1418). The status acquisition unit 301 sends a status change notification to the job management unit 306 and listener processing unit 305 (step S1419).

Upon reception of the status change notification from the status acquisition unit 301, the job management unit 306 updates the management information of the print job 017 in the job management table 315 to an “completed” state (step S1420). Furthermore, the job management unit 306 deletes the “printed job status” generated in step S1410. Then, the job management unit 306 refers to the information of the status cache data 314, and generates and holds an “completed job status”, as shown in FIG. 17C (step S1421).

Since the job management table 315 is updated, the polling target table management unit 303 judges that the print job 017 is completed. Based on this judgment, the polling target table management unit 303 deletes the “device status group” and “output bin information group” from the polling target table 312 (step S1422). As a result, the polling target table 312 holds only the “job status group” information of the print job 017 registered by the listener registration event in step S1404.

Upon reception of the status change notification in step S1419, the listener processing unit 305 refers to the “job progress information” of the status cache data 314, and detects that the “job progress information” of the print job 017 has changed to “completed” (step S1423). After that, the listener processing unit 305 notifies the client PC 101 of that information (step S1424).

After that, since the print job 017 is complete, the status acquisition unit 301 does not acquire the “job status group” information of the print job 017 registered in the polling target table 312, as described above using FIG. 7 (step S1425). Upon generation of the status cache data 314, the status cache data generation unit 302 stores the “completed job status” held by the job management unit 306 in step S1421 in the status cache data 314 (step S1426).

(Print Job Processing Sequence 3)

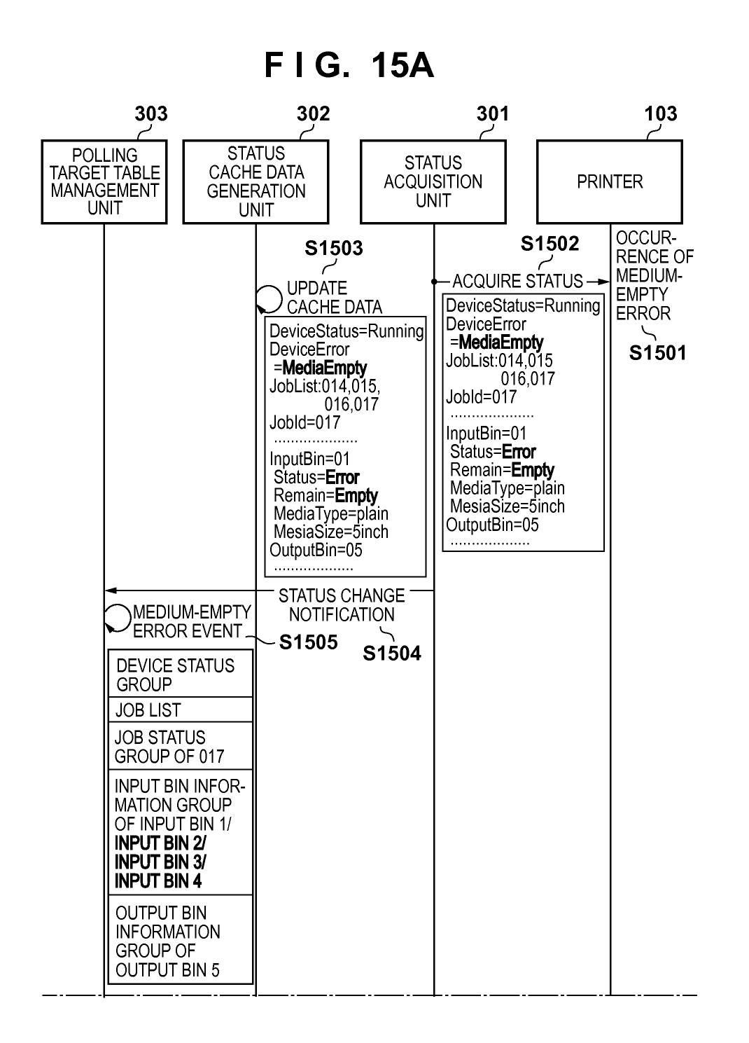

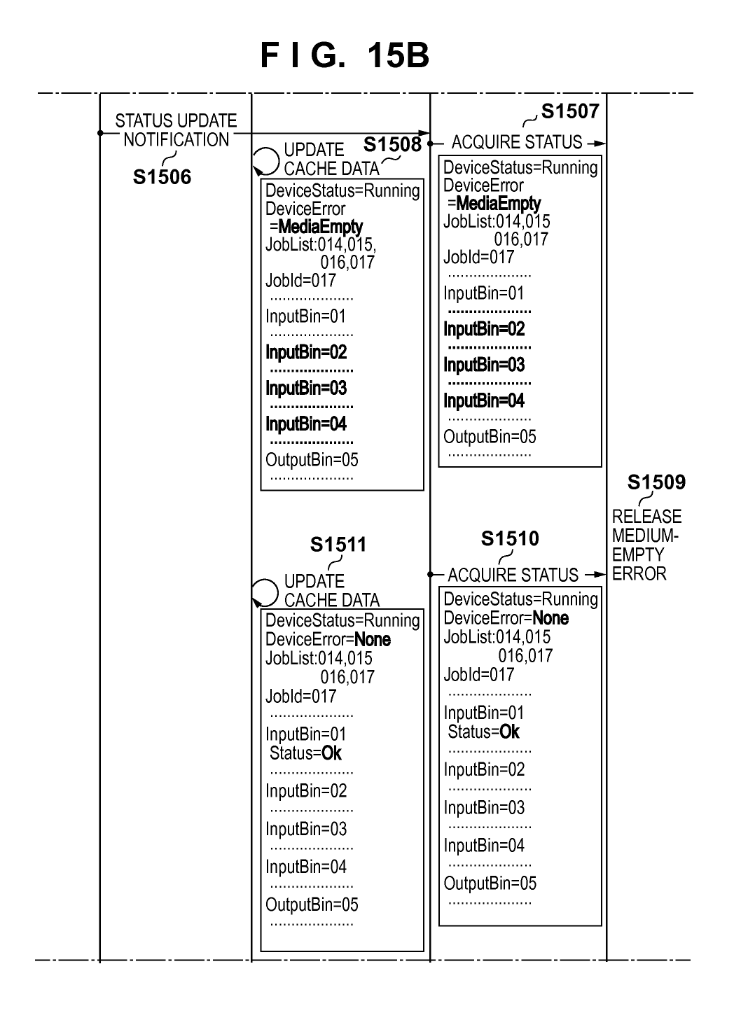

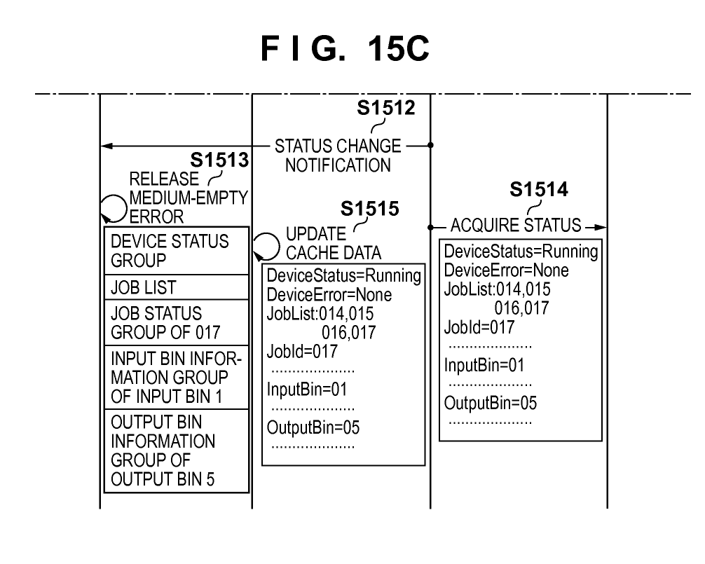

The sequence executed when a medium-empty error has occurred in the print job from FIGS. 13A to 13C will be described below with reference to FIGS. 15A to 15C.

When a medium-empty error has occurred at input bin 1 (not shown) of the printer 103 (step S1501), the status acquisition unit 301 acquires that information (step S1502). Furthermore, the status cache data generation unit 302 reflects that information to the status cache data 314 (step S1503).

The status acquisition unit 301 notifies the polling target table management unit 303 of occurrence of the medium-empty error (step S1504). Then, the polling target table management unit 303 refers to the action table 316 as an event of occurrence of the medium-empty error, and registers “input bin information group” of all input bins in the polling target table 312 (step S1505). After that, the polling target table management unit 303 sends a status change notification to the status acquisition unit 301 (step S1506).

The status acquisition unit 301 acquires the “input bin information group” information of all the input bins defined in the polling target table 312 (step S1507). When the real status data 311 is updated by status acquisition by the status acquisition unit 301, the status cache data generation unit 302 stores the “input bin information group” information of all the input bins in the status cache data 314 (step S1508).

When the operator releases the medium-empty error in the printer 103 (step S1509), the status acquisition unit 301 acquires that information (step S1510). Then, the status cache data generation unit 302 stores information indicating release of the medium-empty error also in the status cache data 314 (step S1511).

The status acquisition unit 301 which detects release of the medium-empty error sends a status change notification to the polling target table management unit 303 (step S1512). Then, the polling target table management unit 303 deletes the “paper port information group” of all the input bins registered in step S1505 from the polling target table 312 (step S1513). However, the “input bin information group” of input bin 1 is left until the print processing of the print job 017 is completed as information registered in step S1319 in FIG. 13B, and is not deleted from the polling target table 312.

After that, the status acquisition unit 301 acquires only information registered in the polling target table 312 from the printer 103 (step S1514). In response to status acquisition by the status acquisition unit 301, the status cache data generation unit 302 reflects that information to the status cache data 314 (step S1515).

(Print Job Processing Sequence 4)

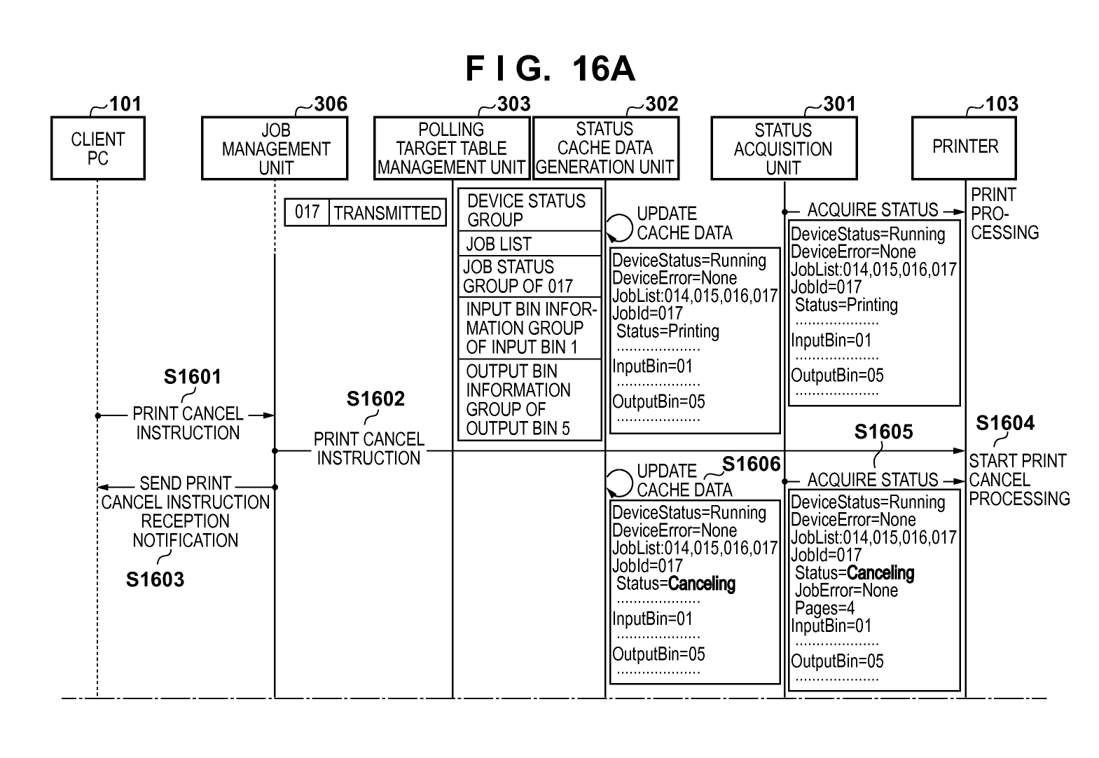

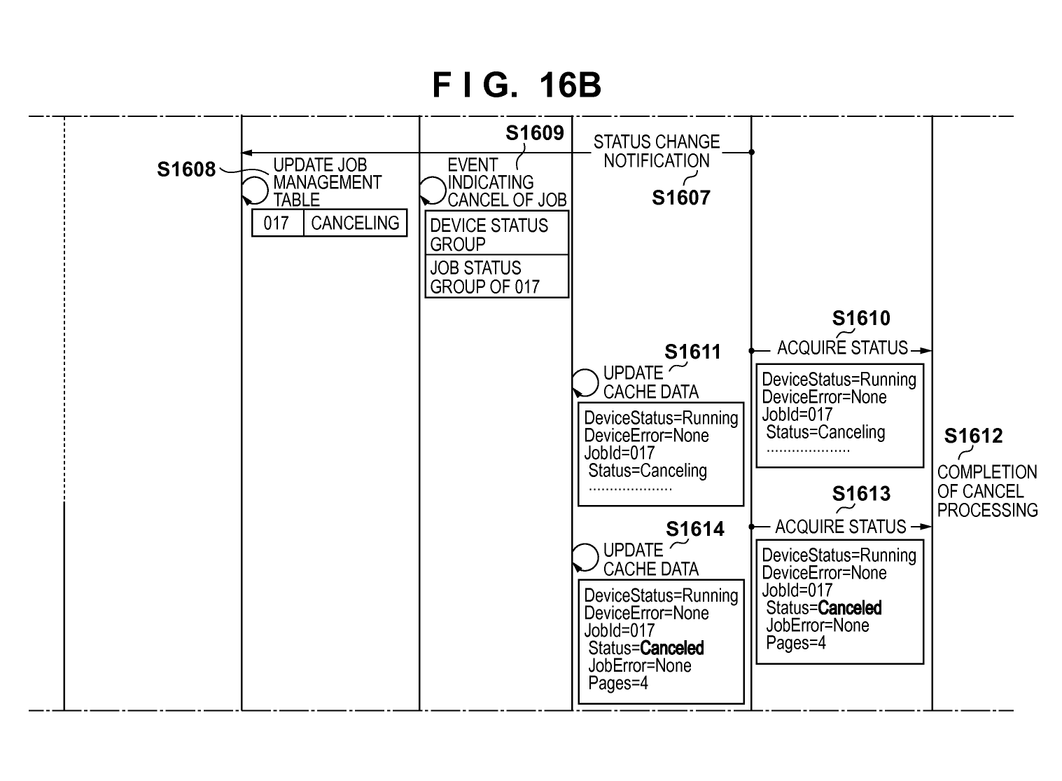

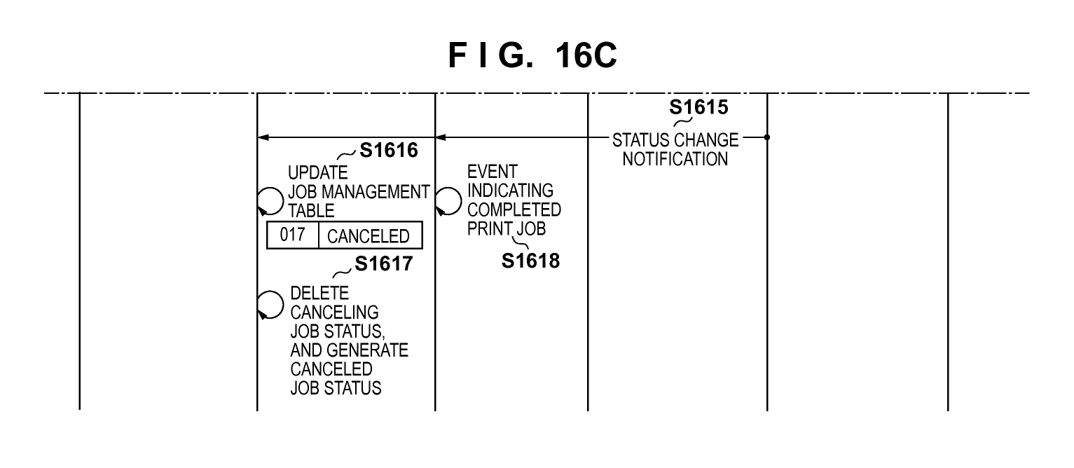

The sequence executed when the operator cancels the print job 017 after FIGS. 13A to 13C from the client PC 101 will be described be described below with reference to FIGS. 16A to 16C.

When the client PC 101 issues a print cancel instruction of the print job 017 in step S1601, the job management unit 306 of the print server 102 receives that instruction. Then, the job management unit 306 notifies the printer 103 of the print cancel instruction (step S1602). The job management unit 306 notifies the client PC 101 that the print cancel instruction is received (step S1603).

Upon reception of the print cancel instruction from the job management unit 306, the printer 103 starts cancel processing of the print job 017 (step S1604).

When the status acquisition unit 301 acquires a status from the printer 103, it acquires information indicating that the cancel processing of the print job 017 is in progress from the “job progress information” of the print job 017 (step S1605). Then, the status cache data generation unit 302 stores that information also in the status cache data 314 (step S1606).

The status acquisition unit 301 notifies the job management unit 306 that the cancel processing of the print job 017 is in progress (step S1607). Upon reception of that status change notification, the job management unit 306 changes the management information of the print job 017 in the job management table 315 to “canceling” (step S1608).

In response to a change in information of the job management table 315, the polling target table management unit 303 judges that the status of the print job 017 becomes “canceling”. Thus, the polling target table management unit 303 deletes the “job list”, “input bin information group” of input bin 1 to be used, and “output bin information group” of output bin 05 to be used from the polling target table 312 (step S1609).

After that, the status acquisition unit 301 acquires information of the “device status group” and “job status group” of the print job 017, which are registered in the polling target table 312 updated in step S1609, from the printer 103 (step S1610). Then, the status cache data generation unit 302 reflects these pieces of information also to the status cache data 314 accordingly (step S1611).

Upon completion of the cancel processing of the print job 017 in the printer 103 (step S1612), the status acquisition unit 301 acquires that information (step S1613). The status cache data generation unit 302 reflects that information also to the status cache data 314 (step S1614).

The status acquisition unit 301 sends a status change notification to the job management unit 306 since the cancel processing is complete (step S1615). The job management unit 306 which received the status change notification changes the management information of the print job 017 in the job management table 315 to “canceled” (step S1616). Furthermore, the job management unit 306 refers to the status cache data 314, and generates and holds a “canceled job status”, as shown in FIG. 17D (step S1617).

The polling target table management unit 303 detects a change of the job management table 315, and judges that the status of the print job 017 becomes “canceled”. Then, the polling target table management unit 303 deletes the “device status group” and “job status group” of the print job 017 from the polling target table 312 (step S1618).

Note that when job status information of the print job 017 is acquired from the client PC 101 after the above processing, it is processed as follows. That is, as described above using FIGS. 8A and 8B, the status cache data generation unit 302 adds the “canceled job status” generated in step S1616 to the status cache data 314. Then, the client PC 101 is notified of the added information.

In the example of this embodiment, the print server as an image processing apparatus efficiently manages the status of the printer as a printing apparatus. However, the present invention is not limited to such specific arrangement. For example, the functions described as the print server may be allocated inside the printing apparatus. In this case, not only external status acquisition but also status acquisition inside the printing apparatus can be efficiently managed.

As described above, since the polling target table 312 is used, only required information is acquired, and the size of the status cache data 314 can be prevented from being increased.

Furthermore, since the related status table 313 is used to simultaneously acquire information of related status items, the number of access times to the printer 103 as the printing apparatus can be reduced by simultaneously issuing an acquisition request of the related status items.

Moreover, the polling target table 312 includes an acquisition condition (polling interval, acquisition time limit, and the like) for each status item to be acquired. Thus, an increase in size of the status cache data 314, and wasteful accesses to the printer 103 can be prevented. Note that conditions designated by the polling target table 312 are not limited to those shown in FIG. 4, and other conditions may be added.

In addition, since the job status and device status are managed together using the related status table 313 and polling target table 312, status management can be simplified.

Also, the progress of a print job is managed using the job management table 315, and a job status of a job which is not transmitted to the printer 103 is generated. Based on this, an access required to acquire a status related to the non-transmitted job can be stopped. Information of a print job whose job status remains unchanged (for example, a non-transmitted job, after completion of a job, and the like) is defined as an invariant status. Thus, the invariant status is controlled not to be acquired from the printer 103, thus stopping wasteful accesses to the printer 103. In this case, a status is acquired by only the first access, and the subsequent status acquisition accesses are stopped. Then, a value acquired by the first access may be continuously held. As for the invariant status, a target status item may be defined in advance, and a most recently acquired status item may be selected as a target.

Furthermore, since the action table 316 defines control of the polling target table 312 in response to, for example, a status change event, status items to be acquired can be managed in an integrated fashion.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-232125, filed Oct. 21, 2011, which is hereby incorporated by reference herein in its entirety.

What is claimed is:

1. A management apparatus, which manages status information of a printing apparatus that processes a print job, comprising:
a status acquisition unit configured to acquire, as the status information, device status information of the printing apparatus and job status information of a print job processed by the printing apparatus;
a status analysis unit configured to analyze the status information acquired by said status acquisition unit; and
a change unit configured to change a status item included in the status information acquired by said status acquisition unit at a next or later time based on information analyzed by said status analysis unit.

2. The apparatus according to claim 1, wherein said status acquisition unit acquires, in response to a status acquisition request, a plurality of pieces of device status information corresponding to the status acquisition request based on a related status table in which status items are grouped.

3. The apparatus according to claim 1, wherein said status acquisition unit acquires the device status information and the job status information based on a polling target table which stores status items to be acquired and conditions for respective groups.

4. The apparatus according to claim 1, further comprising a related status table which combines related status items of status items of the device status information and the job status information for respective groups,
wherein said status acquisition unit acquires the status information for each group defined in said related status table.

5. The apparatus according to claim 4, wherein said change unit changes status items to be acquired by said status acquisition unit for each group defined in said related status table.

6. The apparatus according to claim 1, wherein an acquisition interval is defined for each status item, and
said status acquisition unit acquires the status information according to the acquisition interval.

7. The apparatus according to claim 1, wherein an acquisition time limit is defined for each status item, and
said status acquisition unit suspends acquisition of the status item according to the acquisition time limit.

8. The apparatus according to claim 1, further comprising a status cache data generation unit configured to generate cache data to be held in a cache from the status information acquired by said status acquisition unit,
wherein a status item, a value of which is invariant, is generated as an invariant status,
said status acquisition unit does not acquire the invariant status, and
said status cache data generation unit generates the status cache data using a value of the generated invariant status.

9. The apparatus according to claim 8, wherein status information related to a print job, processing of which is completed, is handled as the invariant status.

10. The apparatus according to claim 9, wherein the invariant status is generated for a most recently acquired status item.

11. The apparatus according to claim 8, wherein status information related to a non-transmitted print job is handled as the invariant status.

12. The apparatus according to claim 8, wherein the invariant status is generated for a status item defined in advance.

13. A management method for managing status information of a printing apparatus that processes a print job, comprising:
acquiring, as the status information, device status information of the printing apparatus and job status information of a print job processed by the printing apparatus;
analyzing the status information acquired in the acquiring step; and
changing a status item included in the acquired status information at a next or later time based on analyzed information.

14. A non-transitory computer-readable medium storing a program for controlling a computer to function as:
a status acquisition unit configured to acquire, as status information of a printing apparatus that processes a print job, device status information of the printing apparatus and job status information of a print job processed by the printing apparatus;
a status analysis unit configured to analyze the status information acquired by said status acquisition unit; and
a change unit configured to change a status item included in the status information acquired by said status acquisition unit at a next or later time based on information analyzed by said status analysis unit.
